(19) United States
(12) Patent Application Publication
(10) Pub. No.: US 2003/0038798 A1
(43) Pub. Date: Feb. 27, 2003

(54) Method and system for processing, compressing, streaming, and interactive rendering of 3D color image data

(76) Inventors: Paul Besl, Michigan, MI (US); Dan Arnold, Milton (CA); Yongjian Zhai, Mississauga (CA); Anu Rastogi, (US)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 10/084,443

(22) Filed: Feb. 28, 2002

Related U.S. Application Data
(60) Provisional application No. 60/272,367, filed on Feb. 28, 2001.

(51) Int. Cl. G06T 17/00

(52) U.S. Cl. 345/420; 345/426

(57) ABSTRACT

A method and system for the processing, compressing, streaming, efficient transmission, and interactive rendering of 3d color image data are presented. A 3d color image is defined as a collection of 3d xyz locations that possess red-green-blue (RGB) color components just as a conventional 2d color image is a set of 2d xy locations (pixel centers) that possess RGB color components. One major difference is that 2d color images are generally dense and specifically organized on a 2d pixel grid where 3d color images are generally sparse and not organized on a dense-voxel grid in their raw data formats. The described method uses 3d sampling techniques and view-dependent point-size rendering algorithms to provide real-time interactive displays of complex textured 3d objects and scenes without the use of specialized texture mapping support for polygons within 3d graphic display systems. By combining this point-based rendering and modeling approach with an efficient data compression technique that offers a high compression ratio, interactive, realistic 3d graphics can be delivered over relatively low bandwidth channels to devices without custom texture-mapping graphics capabilities.

### FIELD OF INVENTION

The present invention relates to computer graphics, including geometric modeling, image generation, and network distribution of content. More particularly, it relates to rendering complex 3d geometric models or 3d digitized data of 3d graphical objects and 3d graphical scenes into 2d graphical images, such as those viewed on a computer screen or printed on a color image printer.

### SUMMARY OF THE INVENTION

Rendering complex realistic geometric models at interactive rates is a challenging problem in computer graphics. While rendering performance is continually improving, worthwhile gains can sometimes be obtained by adapting the complexity of a geometric model or scene to the actual contribution the model or scene can make to the necessarily limited number of pixels in a rendered graphical image. Within traditional modeling systems in the computer graphics field, detailed geometric models are typically created by applying numerous modeling operations (e.g., extrusion, fillet, chamfer, boolean, and freeform deformations) to a set of geometric primitives used to define a graphical object or scene. These geometric primitives are typically converted to texture-mapped triangle meshes at some point in the graphics-rendering pipeline. Conventional computer graphics based on such models and scenes generated using traditional modeling software require difficult, tedious, pain-staking work to arrive at complex realistic models. In many cases, the number of rendered texture-mapped triangles may exceed the number of pixels on the computer screen on which the model is being rendered. However, there is an equivalent simple point-based model that would generate the same finite number of the renderings derived from any of these types of traditional models. To see this, note that for each view that is rendered from such models, one could theoretically back project each 2d rendered pixel to the 3d shape to obtain an (x, y, z) coordinate for each pixel's (r, g, b) color values (red-green-blue). If several views of a complex object were merged together, this would create a large set of (x, y, z, r, g, b) 6-tuple data points, with significant overlap and oversampling.

In contrast to the traditional modeling scenario, it is also possible to digitize scenes and objects in the real world with 3d color scanning systems. U.S. Pat. No. 5,177,556 filed by Marc Rioux of the National Research Council of Canada and granted in 1993 discloses a scanning technology sweeps a multi-color-component laser over a real-world object or scene in a scanline fashion to acquire a dense sampling of (x, y, z, r, g, b) 6-tuplet data points where the (x, y, z) component of the 6-tuplet represents three spatial coordinates relative to an orthonormal coordinate system anchored at some prespecified origin and where the (r, g, b) component of the 6-tuplet represent the digitized color of the point and denote red, green, and blue. Note that any color coordinate system could be used, such as HSL (hue, saturation, lightness) or YUV (luminance, u, v), but traditional terminology uses the red-green-blue (RGB) coordinate system. There are other possible scanning technologies that also generate what we will denote as an Xyz/Rgb data stream. One such technology is a real-time passive trinocular color stereo system (e.g. the Color Triclops from PointGrey Research: http://www.ptgrey.com). Other technologies can also generate Xyz/Rgb images so quickly that a time-varying Xyz/Rgb image stream is created (e.g. the Zcam from 3DV Systems: http://www.3dvsystems.com). All such optical scanners may be thought of as generating a frame-tagged stream of Xyz/Rgb color points. For static scans, the frame tag property will by convention always be zero. The key concept is that there is a relatively new type of digital geometric signal that is becoming more common as time progresses. Previously, the methods for processing this type of data have been fairly limited and few.

When rendering densely sampled 3d Xyz/Rgb data via computer graphic techniques involving lighting models, the surface normals at the sampled points are extremely important to quality of the rendered images. In fact, accurate surface normal data, which we will denote as IJK values (a common engineering unit vector terminology), are sometimes more critical to display quality than accurate Xyz data. In other words, Xyz/Rgb data is often more generally considered as Xyz/Rgb/ljk data for computer graphic rendering purposes. In some cases, the data acquisition systems themselves will output normal vector estimates at the sampled points. In other cases, it is necessary for the rendering system, such as ours, to estimate the normals.

In many areas of analytical computer graphics, 3d XYZ points may instead be complemented with measured physical scalar or vector quantities, such as temperature, pressure, stress, strain energy density, electric field strength, magnetic field strength to name a few. Engineers often view such data via color mappings through an adjustable color bar spectrum. In such cases, the data might be digitized as XYZ/P where P is an N-dimensional arbitrary measurable attribute vector (or N-vector). RGB(P) will denote the color mapping notation. Therefore, even an apparently dissimilar data stream, such as a (xyz, pressure, temperature) stream, can also be viewed as an Xyz/Rgb/ljk data stream for display purposes.

To summarize, there are a wide variety of practical application situations where 3d color pixel data (i.e. Xyz/Rgb/ljk+generalized property N-vector P data) must be processed, managed, stored, and transmitted for visualization purposes. In the case of conventional and analytical computer graphics, one may be starting with a set of triangles that is then rendered through conventional texture-mapped display algorithms or via dense color per vertex triangle models. In contrast, if Xyz/Rgb/ljk/P data is acquired from a physical object via a 3d-color scanner, today's graphics infrastructure requires that this data be awkwardly converted into a texture mapped triangle mesh model in order to be useful in other existing graphics applications. While this conversion is possible, it generally requires experienced manual intervention in the form of operating modeling software via conventional user interfaces. The net benefit at the end of the tedious process is at best minimal.

Performing rendering operations using point or particle primitives has a long history in computer graphics dating back many years (Levoy & Whitted [1985]). Point primitive display capabilities are basic to many graphics libraries, including OpenGL and Direct3D. Recently, Rusinkiewicz and Levoy [2000] have used mesh vertices in a bounding sphere tree to represent large regular triangle meshes. Their implementation and method are referred to as “Qsplat.” Their methods vary significantly from those in this patent document as the bounding sphere tree is the primary data structure from which all processing is done, and the 3d sphere is primary graphic primitive. Spheres are not used in the present invention and our compression results are typically much better (even as much as factor of 10). Displays and other operations require recursive, hierarchical tree traversal. Normal vectors are required to be transmitted with the data according to the published papers and the color is viewed as being optional rather than integral to the data representation. Pfister, Zwicker, van Baar, and Gross [2000] also have presented “surfels” which are somewhat similar to q-splats and our 3d color pixels, but are different in that significant effort is geared toward elaborate texture and shading processing on a per surfel basis. The surfel data structure is quite large compared to Qsplats and both are larger than our compressed 3d pixel representation. Web searches indicate that point-based rendering and modeling literature is growing quickly, but all other published literature besides the above three (3) papers occurred after our provisional patent date of Feb. 28, 2001.

A further detailed comparison reveals the following: Conventional applications might, for example, use all floating point numbers for (x, y, z, r, g, b, i, j, k) which implies that 9 numbers at 4 bytes (32 bits) each is required yielding a total of 36 bytes (288 bits). A modified conventional application might use 12 bytes (96 bits) for the xyz values, 3 bytes (24 bits) for the color values, and 6 bytes (48 bits) for ijk normal values for a total of 21 bytes (168 bits ). Compressed Q-Splats require 6 bytes (48 bits) without color and 9 bytes (72 bits) with color. Surfels require 20 bytes (160 bits) as described in the recent publication. Our basic uncompressed 3d color pixel with no other attribute information requires 8 bytes (64 bits), but numerous additional compression options exist and several have been tested. Our current preferred embodiment of our compression concept uses a specialized 3d Sparse-Voxel Linearly-Interpolated-Color Run-Length-Encoding algorithm combined with a general-purpose Burrows-Wheeler block-sorting text compressor and followed by subsequent Huffman coding. This invention is averaging less than 2 bytes (16-bits) per color point/pixel and for some images do better than 1 byte (8-bits) per 3d color pixel. The best performance occurs on monochrome data sets and has reached as low as 2-bits per 3d point on some 3d scanner data sets. (We believe this is a new record at this time, and that the theoretical limit for subjectively good quality displays is near 1 bit per point).The points encoded in this structure are already sampled so these rates do not benefit from the possibility of encoding nearly duplicate points within the same sparse-voxel, for example. Subjective image quality assessment is generally very good. The following table summarizes this paragraph.

| Name | Organization | Bits per Point |
|---|---|---|
| All Floats (xyz/rgb/ijk) | Conventional | 288 |
| Floats, Bytes, Shorts | Modified Conventional | 168 |
| Surfels | MERL | 160 |
| Color Q-Splat | Stanford | 72 |
| Compressed 3d Image | PointStream | <˜24 (<˜16 typical) |

While the data structure for our claimed invention is not limited to one single compression method or technology, we prefer to view this invention in terms of its data structure properties with respect to the given tasks of interactive display/rendering and efficient transmission, which can be done in any one of several known techniques, or even using techniques unknown or unpracticed at the current time. In other words, the spatial entropy, normal vector entropy, and the color entropy of statistical ensembles of the various levels of our 3d color pyramid (to be defined) admit different approaches for different situations and applications. We currently choose a relatively simple approach to implement a compressor/decompressor that possesses properties at least 3 times better than other known methods.

Because Xyz/Rgb/ljk data streams are a relatively new type of geometric signal, it is currently not possible to predict the net information rate present in a given set of signals at a given sampling distance. In other words, the lower bound on the number of bits per color point for a given image ensemble and a given image quality measure is not known. If one application directly compresses normals as if they are separate from the point geometry and another application does not, this will dramatically affect the minimum number of bits required. From an analytical point of view, it is not clear at the outset how this should be done. Moreover, there is not widespread agreement even in the 2d world as to what quality measures are appropriate. With respect to this type of Xyz/Rgb/ljk signal, we are currently in the “pre-JPEG, pre-GIF” era of development, i.e. in a state of flux.

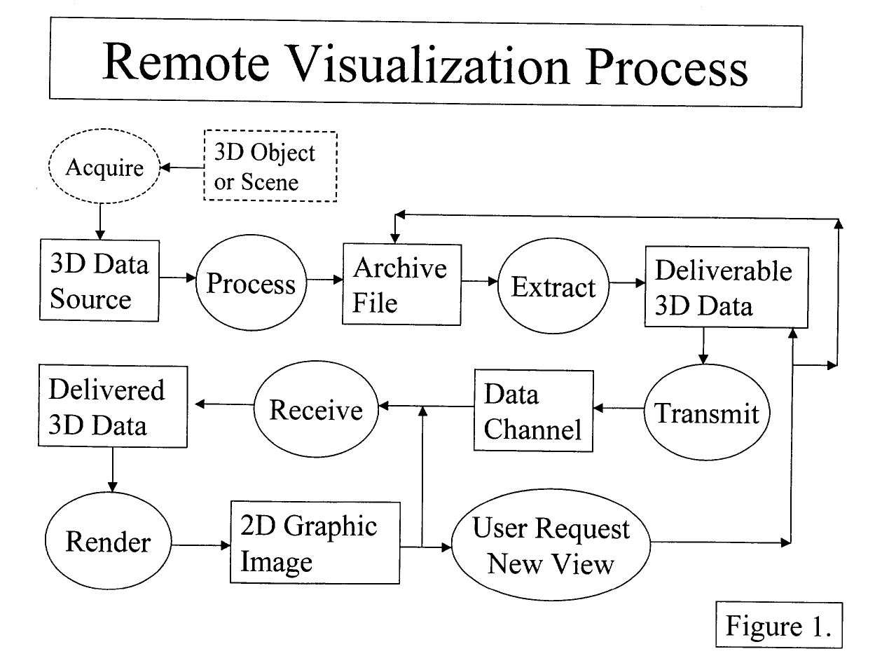

The present application uses 3d data in a method that varies significantly from conventional computer graphics and differs substantively from other previously published point display and rendering methods with respect to how the data is organized, displayed, compressed, and transmitted. A data flow context diagram of the invention is shown in FIG. 1. A source of 3d geometric and photometric information is used to create 3d content that is to be viewed in a client application window. The present invention provides an infrastructure for the simplest and most rapid deployment currently possible of complex, detailed 3d image data of real, physical objects. We believe our 3d compression algorithms currently exceed the capabilities of other existing technology when used on highly detailed, photorealistic 3d geometric and photometric information.

Definitions

A three-dimensional color pixel (3d color pixel) is defined as a 3d point location that always possesses color attributes and may possess an arbitrary set of additional attribute/parameter information. The fundamental data element associated with a 3d pixel is the 6-tuple (x, y, z, r, g, b) where (x, y, z) is a 3d point location and (r, g, b) is (nominally) a red-green-blue color value, although it could be represented via any valid color coordinate system, such as hue-saturation-lightness (HSL), YUV, or CIE. A 3d color pixel will typically be associated with a slot for a 3d IJK surface normal vector to support computer graphic lighting calculations, but the actual values may or may not be attached to it or included with it, since the surface normal vector at a 3d color pixel can often be computed on the fly during the first lighted display if they are not specified in the original data set. This is advantageous for data transmission and storage, but does require additional memory and computation in the client application at image delivery time. 3d color pixels can also be referred to as sparse-voxels for certain types of algorithms.

A three-dimensional color image (3d color image) is defined as a set of 3d color pixels.

A 3d color image may or may not be regular. A 3d color image is also known as a color point cloud, an Xyz/Rgb data stream, a 3d color point stream, or a 3d color pixel stream.

A regular three-dimensional color image (regular 3d color image) consists of a set of 3d color pixels whose (x, y, z) coordinates lie within a bounded distance of the centers of a regular 3d grid structure (such as a hexagonal close pack or a rectilinear (i.e. cubical) grid). As a result, for each 3d color pixel in a well-sampled regular 3d color image, a neighboring 3d pixel must exist within a specified maximum distance. That is, no 3d color pixel should be isolated. Moreover, a well-sampled regular 3d color image guarantees that at most one 3d color point exists within the regular grid's cell volume surrounding the center of the regular grid cell. The information identifying the regular grid structure is defined to be a part of a regular 3d color image.

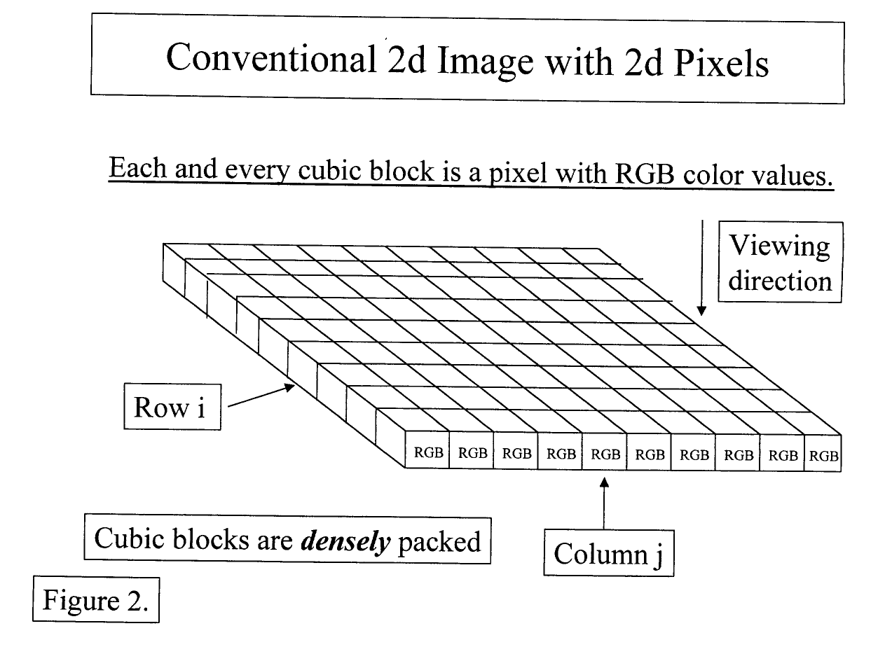

FIG. 2 shows a traditional dense 2d color image data structure as a regular 3d color image data structure where, for example, the z spatial component is constant.

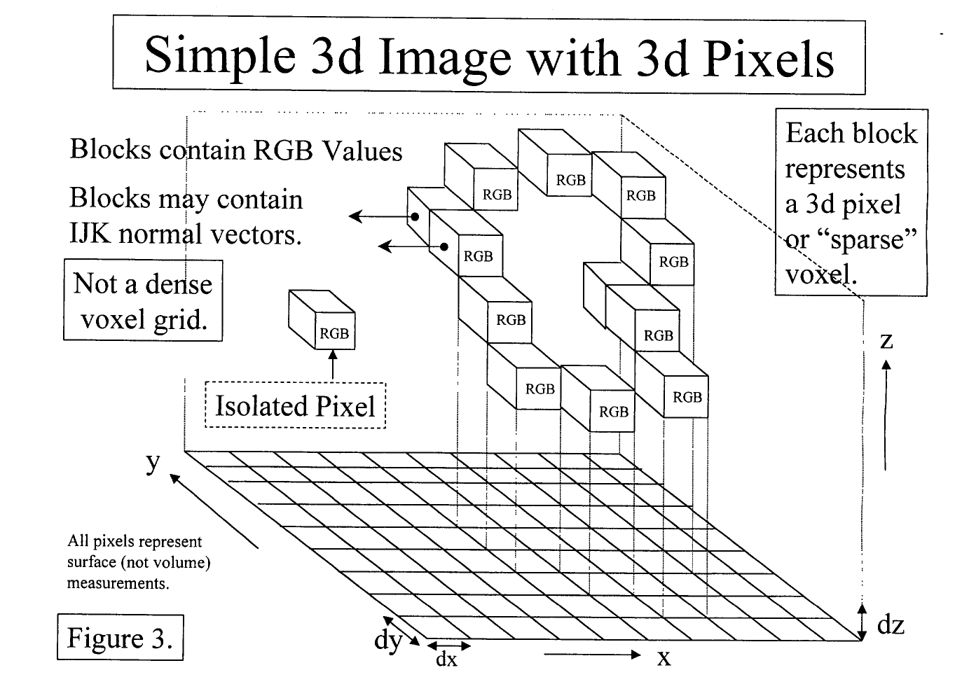

FIG. 3 shows a simple, very sparse 3d color image. It is not strictly regular since it contains one isolated 3d pixel. If that pixel were removed, then the data shown in FIG. 3 would be a regular 3d color image.

It should be noted that our terminology may appear similar to that used in volume image processing. However, in volume image processing, the 3d voxel arrays are always essentially dense. Data is actually represented at each and every voxel. For example, with medical computed tomography (CT) data, there is a density measurement at each voxel. That density measurement may quantify the density of air relative to the density of the material of an object, but the domain of the measurements completely and densely fills a given volume. In our 3d color images, we are essentially concerned only with surfaces, not with volumes. However, we treat the surfaces as a “2D dense” collection of points, and sometimes as voxels. Our data representation does not in general concern itself with “3D dense” collections of voxels. When this topic is important in the context of a voxel-based algorithm in the system (as opposed to a tree-based approach), we also refer to 3d color pixels as sparse-voxels.

A non-regular three-dimensional color image is a 3d color image that is not regular. For example, the 3d color pixel data that comes from a scanner after all views have been aligned is non-regular owing to its oversampling and possibly isolated outliers.

An oversampled three-dimensional color image is a 3d color image where at least one point (and usually many more) possesses a nearby neighboring 3d color pixel that is located within a pre-specified minimum sampling distance of another 3d color pixel and within the same regular-grid cell volume associated with the given point.

An undersampled three-dimensional color image is a 3d color image where at least one and typically many 3d color pixels have no near neighbors with respect to the pre-specified sample distance. The term “many” is quantifiable as a percentage of the total number of 3d color pixels in the image. For example, a 10% undersampled 3d color image has 10% isolated 3d color pixels. In this context, one rule of thumb might be that a sampling distance is too small if the associated regular 3d color image for that sampling distance has more than e.g. 5% isolated pixels.

A three-dimensional color image pyramid (3d color pyramid) is a set of regular, well sampled (i.e. not undersampled) 3d color images that possess different sizes and different sampling distances. In a given implementation, it may be likely that the sizes in x, y, and z directions and the nominal sampling distance will vary by powers of two, but this is not required by the definition with respect to the present invention. Note that the pyramid is not a conventional oct-tree since pixels at a given level are accessible without tree search.

A 3d color pixel may or may not contain additional attribute information. Additional attribute information may or may not contain a normal vector. Any 3d color pixel data may or may not be compressed. Any 3d color pixel data may or may not be implicit from its data context. The normal vector at a 3d color pixel can be estimated from nearby 3d color pixels when a set of 3d color pixels are given without additional a priori information outside the context of the regular 3d color image, or the normal vector can be explicitly given.

Example: Every JPEG, BMP, GIF, TIFF, or any other format 2d image is a regular 3d color image of the type shown in FIG. 2, which happens to also be a type of regular 2d color image. 2d color images that lie within a rectangle seldom explicitly represent the spatial values of color pixels since it is seldom of any benefit in two dimensions owing to the dense sampling. Note also that neighborhood lookup is much simpler in 2d than in 3d.

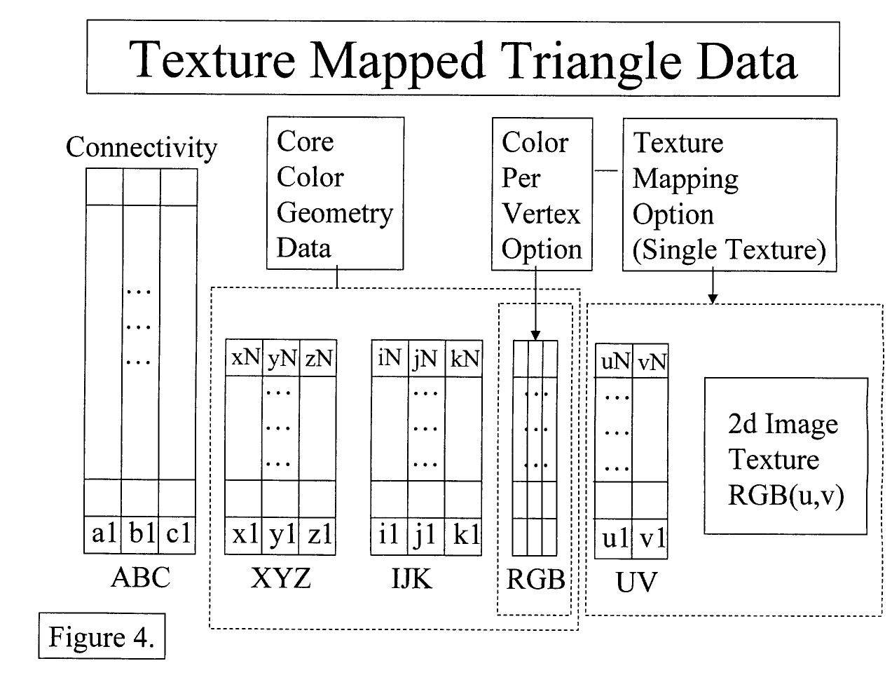

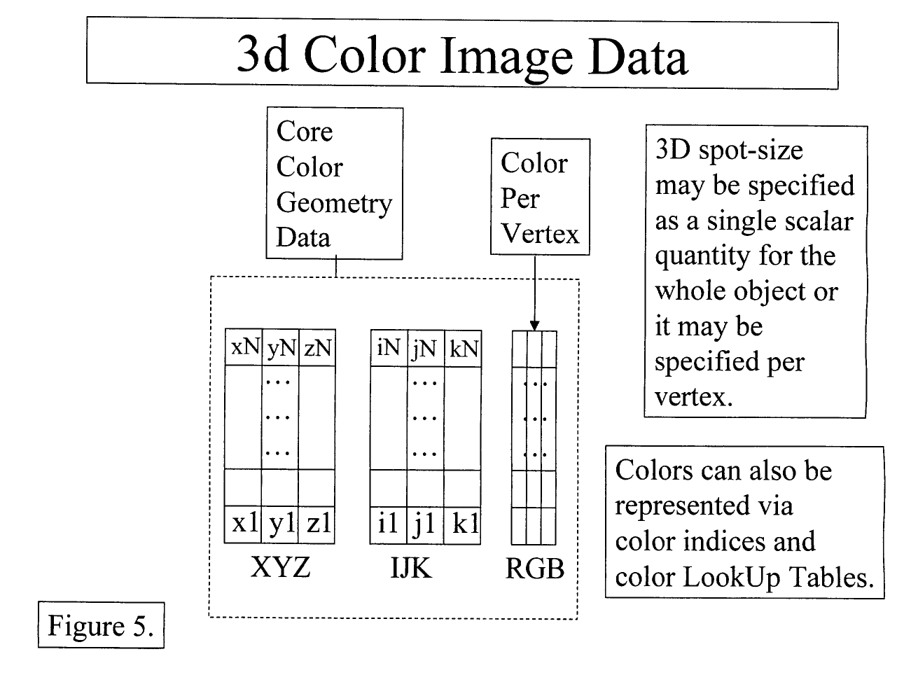

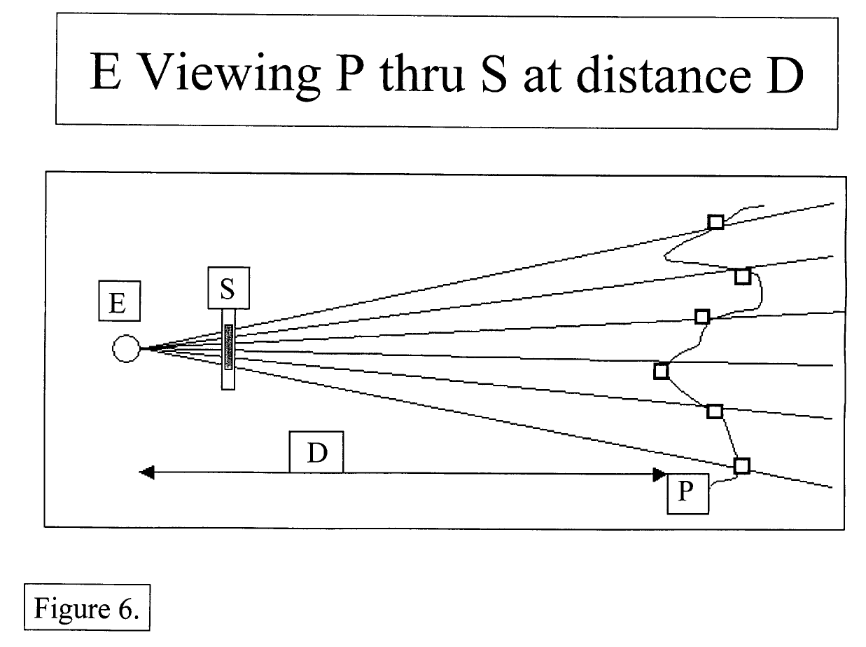

The present invention provides a fast and high quality rendering for 3D images. The image quality is similar to what other existing graphics technology can provide. However, the present invention provides a faster display time by doing away with conventional triangle mesh models that are either texture-mapped or colored per vertex. The simplest way to describe the invention is to examine a situation where one wishes to view e.g. a very complex 10 million triangle model (this may seem large, but 1 and 2 million triangle models are quite common today). Typically, such a model would consist of approximately 5 million vertices (XYZ points) with normal vectors and texture mapping (u, v) [or (s, t)] coordinates. In addition, the connectivity of the triangles is typically represented by three integer point indices that allow lookup of the triangle's vertices in the vertex array. See FIG. 4 for a diagram showing typical array layouts for texture mapped triangle meshes. A typical 1280×1024 computer screen however contains only 1.3 million pixels. Even the best graphic display monitors today (2002) seldom exceed 2 million pixels. A complex model then might contain 2.5 triangle vertices [or 5 triangles] per pixel. The model is then considered to be oversampled relative to the computer screen resolution. If the graphics card of a computer does not support multisampling graphics processing, then one is wasting a lot of time and memory fooling around with conventional triangle models since a pixel in a 2d digital image can only hold one color value, which of course does not need further processing. In such oversampled cases, one can ignore the triangle connectivity in a significant subset of possible viewing situations and render only the vertices as depth-buffered points and still get an essentially equivalent computer generated picture. In this situation, the graphics card need only perform T&L operations (transform and lighting) without the intricacies of texture mapping or triangle scan line conversion. See FIG. 5 for a diagram showing the layout of the data for a 3d color image. We are basically suggesting the possibility of abandoning triangle connectivity and texture images and uv texture coordinates for high-resolution 3d scanner data and skipping any meshing phase. Other research has shown that there is generally not very much information in a triangle mesh connectivity “signal.” In addition, 3d content creation artists spend a great deal of time arranging, compiling, editing, and tweaking texture images to get the correct appearance. Yet with lower-bandwidth suitable models, one often sees quite a bit of texture stretching and other texture mapping artifacts. We believe that the 3d color images produced by the present invention can deliver high quality imagery while being compatible with low bandwidth constraints.

Of course, to those skilled in the art, this approach may seem limited to the oversampled situation because when you zoom in [or dolly in] on a model or scene, you will eventually reach the undersampled situation where there are many fewer points in the view frustum than there are pixels in the image. (This undersampled condition is the usual computer graphics situation for the last 35 years. We are only now entering the oversampled stage owing to the desire for increased realism and the availability of Xyz/Rgb scanners.) The image generated from rendering only colored points will no longer look identical to the picture generated using a triangle mesh model because the colored point display method will no longer interpolate pixels on the interior of a triangle. The generated picture by the naive simplified algorithm above for the oversampled case would generally be unintelligible based on what we have described thus far.

Next imagine that the vertex spacings for the original triangle mesh are sampled on a regular 3d sampling grid so that no two points on any given triangle are further away from each other than a prespecified or derived sampling distance. Two sampling grids that are useful to consider are the 3d hexagonal close pack grid and a 3d cubical voxel-type grid. In this case, we could simply draw the points larger so that they occupy the necessary number of pixels to provide a solid fill-in effect. As you zoom in, you will see artifacts of this rendering alternative just as you see polygonization artifacts when you zoom in on a polygon model rendered with conventional smooth or flat shading.

The first order solution to this alternative rendering problem is to make the 2d pointsize of a rendered point just large enough so that it is not possible for inappropriate points to show through when all points are z-buffered as they are displayed. In the general solution, each point might cause a different number of pixels to be filled in. We have found experimentally that for the type of Xyz/Rgb data generated by the NRC/Rioux scanner it is often possible to get sufficiently high quality displays by even assigning a single point-size to all points on a given object of a given spatial extent, or on all points in arranged subsets of the total color point set.

For an anti-aliased display more comparable to high quality traditional renderings, one can also use conventional jitter and average methods based on accumulation buffers to improve display quality. This option trades off additional display time for additional quality. Other “increased memory cost” options for improved resolution are also possible. Simply render the 3d color image at a higher resolution in memory and then average adjacent pixels in the higher resolution image to create the lower resolution output screen image.

In general, we can manage our graphic model in a hierarchical manner where the smallest sampling interval corresponds to the highest generated image quality. Coarser displays use coarser sampling. The hierarchical sampling method is described in more detail in the later sections. The goal of the display methods and the hierarchical multi-resolution data management is to provide the best quality display using the least amount of transmitted data.

This invention brings together a set of methods for dealing with a novel rendering and modeling data structure that we refer to as the 3d color image pyramid, which consists of multiple 3d color images with 3d color pixels. The contents of a 3d color image can be converted to a color sparse-voxel grid or oct-tree, a color point cloud, an Xyz/Rgb/ljk data signal, etc. The 3d color image compression method seems able to reduce the data required for a color point cloud down into the range of about 1 to 2 bytes per color point. Although it may seem a bit odd since we only store point data and a few other numbers, the 3d color image can actually be used as a true solid model if sufficient data is provided. It is then possible to derive stereolithography file information from a color scan as well as it is possible to compute cutter paths. If a modeling system were created that allowed people to easily sculpt and paint the 3d color images interactively, it would be possible to design, digitize, render, and prototype all using the same underlying representation. The 3d color image and pyramid can provide a unified, compact, yet expressive data representation that might be equally useful for progressively transmitted 3d web content, conceptual design, and digitization of real-world objects.

It should be understood that the programs, processes, and methods described herein are not related or limited to any particular type of computer apparatus (hardware or software), unless indicated otherwise. Various types of general purpose or specialized computer apparatus may be used with or perform operations in accordance with the teachings described herein.

### DETAILED DESCRIPTION

The basic principles of the invention are as follows. Let the eye be positioned at a point E in three dimensions. Let the eye be observing a depth profile P at a nominal distance D through a computer screen denoted as S. This is shown in FIG. 6.

FIG. 6 Caption. The eye E views a profile P with six samples at a distance D. The profile is viewed through a computer screen S with six pixels.

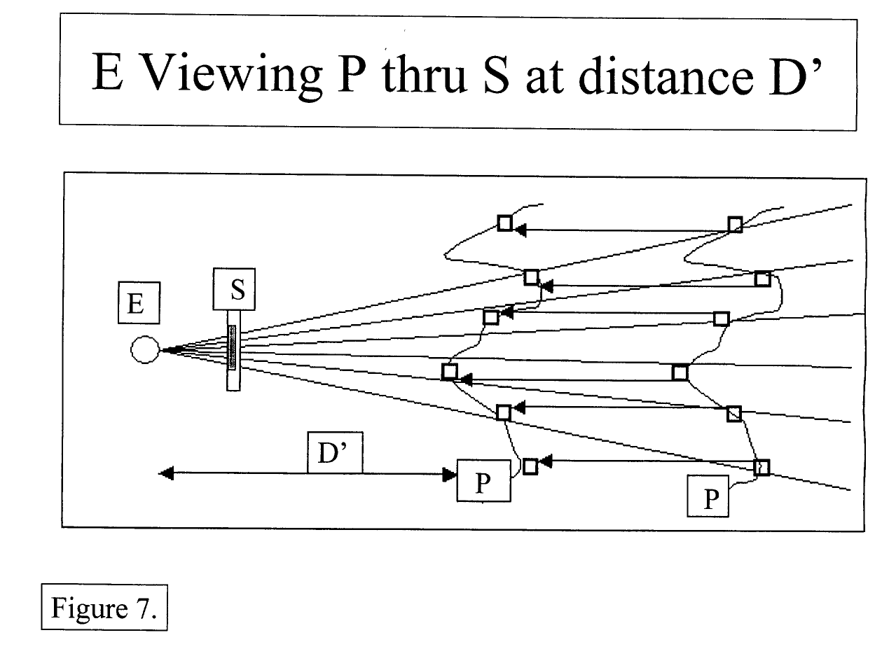

FIG. 7 Caption. The eye E views the same profile P′ with same six samples translated to a distance D′. The profile is viewed through a computer screen S with six pixels as before but only four sample points contribute to the zoomed-in image.

FIGS. 6 and 7 show the effect of moving a profile shape toward the eye as it views the profile through a computer screen with six pixels. In FIG. 6, we say the six sample points fill the field of view. Each 3d point corresponds to a single pixel on the screen. However, in FIG. 7 the six sample points exceed the eye's field of view. Two points are no longer visible to the eye. So we have 4 points visible on a screen that has 6 pixels. If we actually knew the underlying shape of the profile P, we could resample it again at the closer distance D′ (as would take place in convention raycasting or z-buffering display methods). This provides the best graphical display given that profile information. However, we could draw each of the 4 visible samples with a point-size of 2 pixels. Note that 2 pixels will get hit twice since 4 points drawn with 2 pixels is a total of 8 pixels where only 6 pixels are actually available. This will cause the field of view to fill in and for the resultant image to appear solid. This image will be different than the image created by resampling the profile as traditionally is done in computer graphics. The key aspect of the invention is that any method that allows drawing the 4 points into six pixels so that all 6 pixels have an object/profile color assigned is a reasonably good approximation to what you would get doing conventional graphics operations. The other aspect is that if you are given only the samples as stated here, it is not necessary to build an interpolatable model to get a reasonably high quality picture.

Similarly, if the profile is moved away from the eye, the six samples might then be concentrated with the span of 4 of the six original pixels. In traditional computer graphics, the underlying profile would be sampled at the 4 new locations. In the claimed invention's method, the six samples would be drawn into the 4 pixels yielding the results of only 4 samples (assuming no blending is done for now at the z-buffer/color buffer overlap case). If the profile moved far enough away to only occupy 3 pixels, then the profile could be rendered with the present method by only drawing every other point, that is by decreasing the number of points drawn.

In general, given a relatively uniformly spaced Xyz/Rgb data set, we will draw the data on the screen once. The average number of points per occupied image pixel determines the appropriate action. As an example, there exist distances and point spacings such that when far away, we can draw every other point; when closer, we draw every point; when closer still, we draw every point, but draw it at twice the size. This basic logic can be formulated and implemented in several different quantitative ways. We provide the details of one implementation for this type of algorithm.

Alagorithm Implementation

External Data Sources provide the input data.

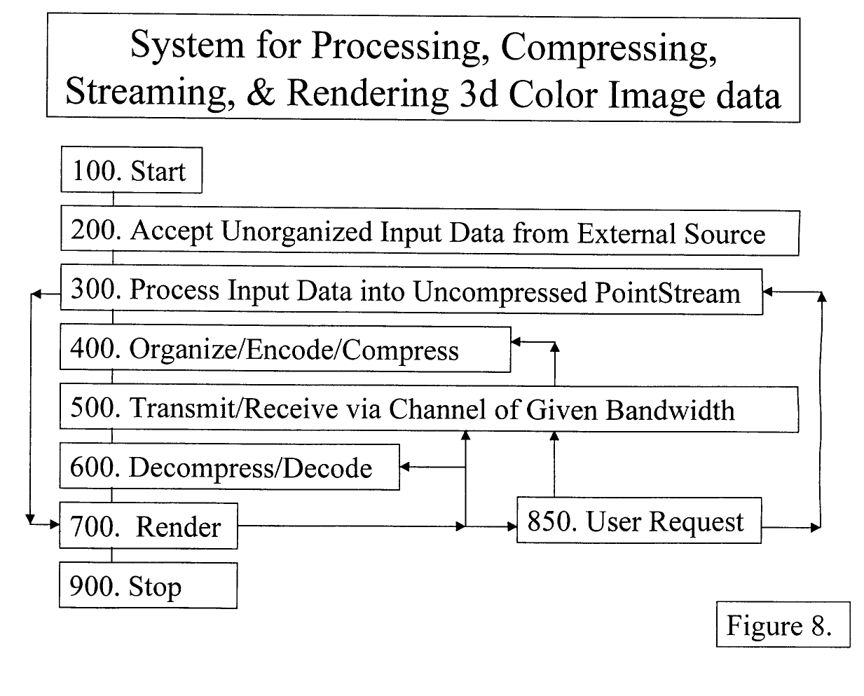

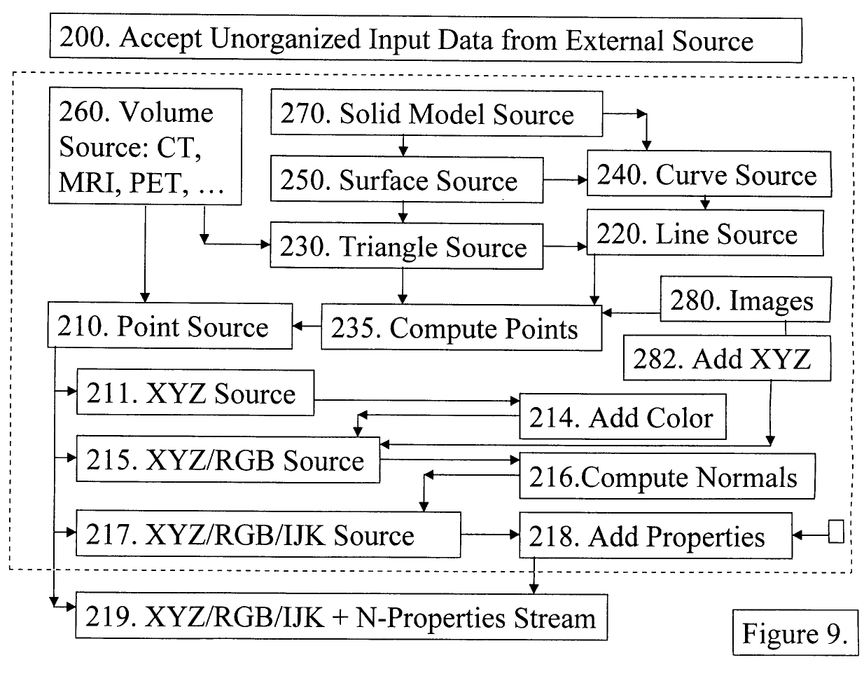

FIG. 8 shows a flowchart for the entire system context. Step 100 represents the start point and Step 900 represents the Stop point for the type of processing this invention is capable of. Step 200 represents the input step. Just as a 2d image processing system accepts input from external systems, so it is with our 3d image processing system. However, because our system is geometric and photometric as opposed to being simply photometric like a 2d image processing system, our system can theoretically accept input from numerous forms of 3d geometry. FIG. 9 indicates the wide variety of data types that can be reformatted as a point stream, or 3d color image. In other words, the eventual application of this invention is geared to, but not limited to, 3d color scanner data.

The obvious cases are indicated under the Step 210 heading in FIG. 9, which elaborates the context of Step 200. A point source can generate Xyz (Step 211), Xyz/Rgb (Step 215), Xyz/Rgb/ljk (Step 217), Xyz/ljk with constant Rgb, in general, an Xyz/Rgb/ljk/P stream of data (Step 219) where P is an arbitrary N-dimensional property vector. We make specific note that if one receives Step 211 type data, it is possible to execute a Step 214 to “Add Color” to the Xyz stream. For example, it is possible to add acquired texture map images represented as Step 280, or it is also possible for the 3d content capture/creation artist to use “3d paint” software to attach colors to the data. While “3d paint” is not a novel invention, we believe it is a novel invention to paint on a point cloud using a rendered 2d image of the type generated by our 3d image rendering methods. Tests with implemented software indicate that our 3d paint is relatively free of the types of artifacts found in surface and polygonal texture mapped 3d paint options. This occurs because we are not restricted by an original triangle mesh.

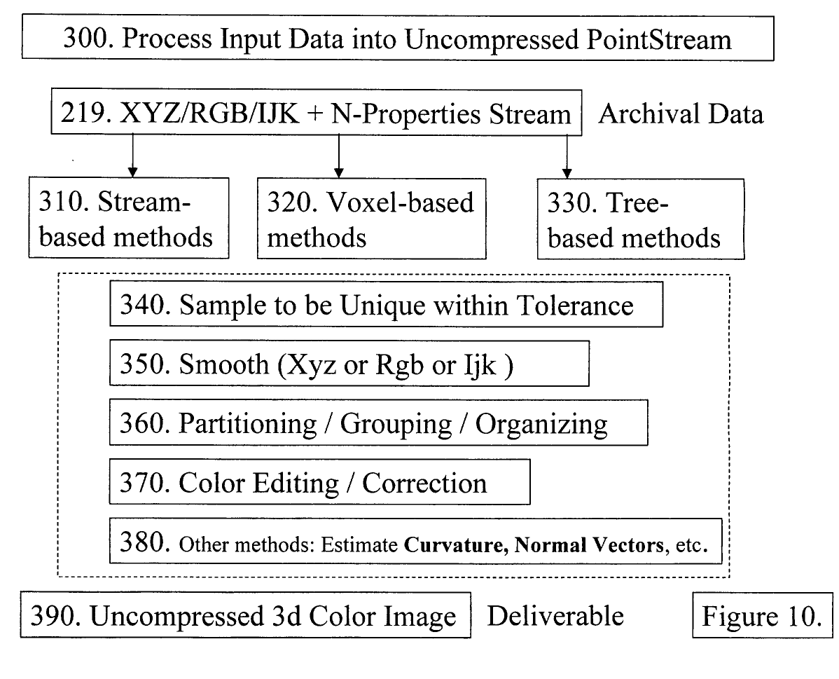

If one receives Step 215 type data, one can compute surface normals at points using Step 216 methods for computing normals. This step may use sparse-voxel-based methods or tree-based methods indicated as step 320 and step 330 in FIG. 10. Step 216 involves 3 sub-steps:

1. Access neighboring points using k-d trees or sparse-voxel representation.

2. Average the normal vectors of the neighborhood.

3. Renormalize the average vector.

Step 218 is labeled as “Add Properties.” For example, different parts of a color point cloud may belong to different objects. An object label is a useful type of added property. In data acquisition, the pressure or temperature at the given points may also have been measured and can be an added property. Similarly, the actual scan structure of a color point cloud might be preserved in some applications by adding a “scan id” property.

Step 282 is called “Add Xyz.” In photogrammetric applications and in artist modeling applications, these systems may start with a regular 2d camera image where Xyz information is added to the Rgb values of the pixels via photogrammetric matching or via 3d content creation artist input.

Step 220 converts line data from a Lemoine-type or MicroScribe-type touch scanner into a 3d point cloud by sampling the line data at small intervals. Step 240 indicates curve sources, and though relatively rare in real applications, they are included for mathematical completeness. Curves can be converted to line data, which can then be converted to point data. Sample line scanners, although less common than optical scanners, are shown at the following URLs:

http:www.lemrtm.com/digitizing.htm

http://www.immersion.com/products/3d/capture/overview.shtml,

http://www.rolanddga.com/products/3D/scanners/default.asp

Step 230 converts triangle mesh source data into a point cloud using the following algorithm.

(a) check the lengths of the edges of a triangle,

(b) if all edge lengths are less than a given sampling interval, output the 3 vertices and optionally the center of the triangle to an output queue of unique 3d points,

(c) if one edge length is greater than the sampling interval, subdivide triangle into 4 sub-triangles where each triangle has edges that are half as long as the original triangle.

(d) Repeat steps (a), (b), (c) on each of the four triangles created in step (c).

Step 250 converts spline surfaces into triangles via existing, known triangle tessellation techniques. Triangles are then converted via step 230 above to create a point cloud/stream.

Step 270 converts a solid model into surfaces via existing, known surface extraction techniques to convert solid models into the set of bounding surfaces. Most dominant CAD/CAM system in industry represent geometric models using solid modelling methods.

Once surfaces are extracted, they are converted to triangles, and then to points as described above.

Step 260 converts volume source of geometry into points. For example, computed tomography (CT), magnetic resonance imaging (MRI), and positron emission tomography (PET) scanners all create densely sampled 3d volume information. Commercial systems can convert this data into triangle meshes or points directly. If triangle meshes are created, Step 230 is used to convert that data in a set of point cloud/stream data compatible with our general definition of Step 219.

The above description is included in this patent to make it very explicit that the present invention is applicable to many different forms of geometric information. Whenever colors or other photometric properties are provided with geometry models, these values can be passed on to our Step 219 format. If such properties are not available, the 3d content creation artist can add colors and other photometric properties to the data set.

Step 300 summarizes a set of processes that can be optionally applied by the 3d content creation artist to the 3d color image data (a.k.a. 3d color point cloud, 3d color point stream). In general, we can classify methods as stream (or sequential point list)-based (Step 310), sparse-voxel-based (Step 320), k-d tree based (Step 330), or other. Some of the possible processes allow you to do the following:

sample a cloud so that you only have one unique point within a tolerance distance of any other point (Step 340),

smooth the spatial Xyz values, the color Rgb values, or the normal vector Ijk values via averaging with neighboring points (Step 350),

partitioning, grouping, organizing points into smaller or more logical groupings, such as the spatial subdivisions mentioned in the normal vector compression section (Step 360),

color editing and correction (Step 370),

other computations, such as curvature estimation or normal vector estimation (Step 380),

In each case, the essentially raw archival data is processed into an uncompressed format, ready for compression. We give the details in the next section for how to organize encode and compress the point data into a compressed (ready to transmit) stage.

Step 400

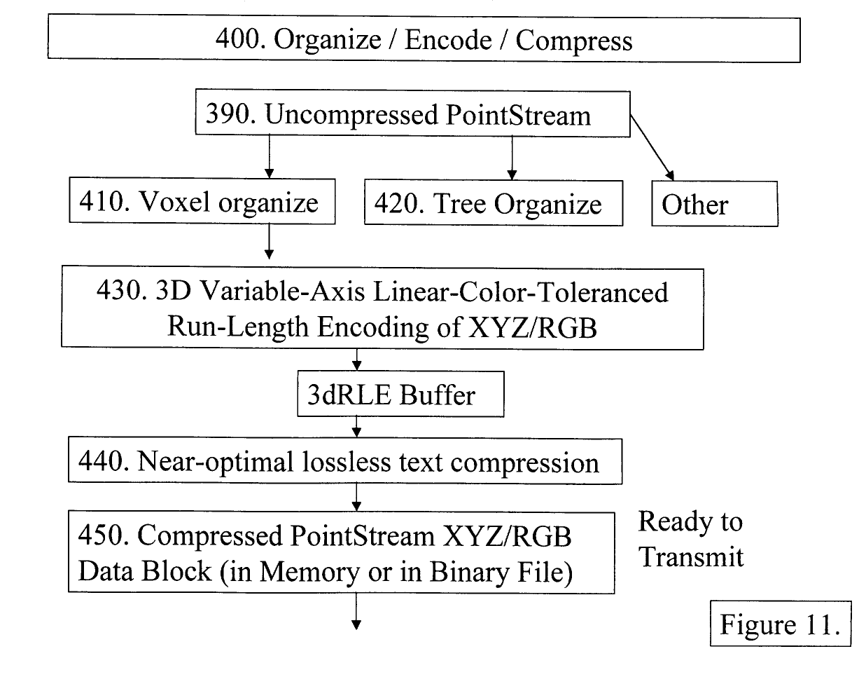

Given an arbitrary, densely-sampled Xyz/Rgb 3d color image (indicated as step 390) that represents a surface, we first wish to obtain a single uniformly sampled regular 3d color image. Typically, the raw 3d scan data that comes from a color scanner represents a series of multiple 3d snapshots from different directions. When multiple views of data are merged, there is typically quite a bit of overlap between the different snapshots/views. This causes heavy oversampling in the regions of overlap. The following groups of steps (labeled as Step 410 and Step 430 in FIG. 11) can be employed in the processing of the raw data to create the types of data structures mentioned above.

Step 430a. A Bounded 3d Color Image per Real World Object: Compute bounding box for the entire set of 3d points. This yields a minimum (Xmin, Ymin, Zmin) point and a maximum (Xmax, Ymax, Zmax) point, and a range/box-size for each direction. This is a straightforward calculation requiring O(N) memory space to hold the data and O(N ) time to process the data.

Step 430b. 3d Color Image Quality Determinants: Determine sampling quality for the 3d color image to be produced. Start with either a nominal delta value or a nominal number of samples. Divide xyz ranges by delta. This yields Nx, Ny, Nz: the sampling counts in each direction. The resulting values are those values that provide the most cubic sparse-voxels. [Sparse-voxels require memory on the order of (CubeRoot(Nx*Ny*Nz) squared) as opposed to dense-voxels, which require memory on the order of (Nx*Ny*Nz).]

Nx′=CastAsInteger[(Xmax−Xmin)/delta]

Ny′=CastAsInteger[(Ymax−Ymin)/delta]

Nz′=CastAsInteger[(Zmax−Zmin)/delta]

Then scale the Nx, Ny, Nz values to the desired level of sampling, or scale the dx, dy, dz values to the desired level of sample distance. This specifies a uniform rectangular sampling grid to be applied to the unorganized data set. The following shows the relationship between the sampling intervals (dx, dy, dz) and the numbers of samples:

dx=(Xmax−Xmin)/(Nx−1)

dy=(Ymax−Ymin)/(Ny−1)

dz=(Zmax−Zmin)/(Nz−1)

The values of dx, dy, dz point spacings are indicated in FIG. 3. Step 430c. Sampling Methods on 3d Color Images: For each (Xi, Yi, Zi) value in the file, we compute the integerized coordinates within the 3D grid that may be expressed as follows:

ix=CastAsInteger[(Xi−Xmin)/dx+0.5)

iy=CastAsInteger[(Yi−Ymin)/dy+0.5)

iz=CastAsInteger[(Zi−Zmin)/dz+0.5)

Each (ix, iy, iz) coordinate specifies a sparse-voxel location. When more than one point exists in a given sparse-voxel, we average the point coordinates to get the best average point and the best average color to represent that sparse-voxel. The processing is done incrementally storing only one point and color for each occupied sparse-voxel along with the number of points occupying that sparse-voxel. This helps keep memory usage low.

Ni=0 for all i

Xavg=Yavg=Zavg=0

Ravg=Gavg=Bavg=0

ForEach (i in the Xyz/Rgb[i] pointstream)

{

Ni = Ni + 1
Wi = 1 / Ni
Xavg = Wi*Xi + (1−Wi)*Xavg
Yavg = Wi*Yi + (1−Wi)*Yavg
Zavg = Wi*Yi + (1−Wi)*Zavg
Ravg = Wi*Ri + (1−Wi)*Ravg
Gavg = Wi*Gi + (1−Wi)*Gavg
Bavg = Wi*Bi + (1−Wi)*Bavg

}

The final result of the processing algorithm above is a regular 3d color image. Every point is within s=2*sqrt(3)*max(dx, dy, dz) of another point if the sampling is dense compared to the point spacing to avoid significant sparseness.

Note that the resulting set of points yields exactly one point per spatial voxel element, but the xyz position is not equivalent to the voxel center position. This is one of the key variations between the 3d color image data structure of the present invention and other conventional spatial structures. Whereas the input X, Y, Z values from a scanner are conventionally represented as floating point values, we scale sensor values into a 16 bit range since few, if any, spatial scanners are capable of digitizing position accurately within the 16 bit range.

Using the above method, the actual average of the X, Y, Z values for the points in each sparse-voxel (i.e. the sub-voxel position) are recorded. The sub-voxel position can be an important factor in rendering quality. In the run-length encoding method described below we describe a technique which discards sub-voxel position for the sake of transmission bandwidth and makes pixel/voxel positions implicit as in 2d conventional images rather than explicit as in an Xyz/Rgb pointstream. In a system where the highest quality is desired, the sub-voxel position may be transmitted and used to provide a more precise and higher quality image. In a system where the sub-voxel position will not be used to render a 3D image, it is not necessary to calculate or record it.

Step 800. Multiple Image Level [Pyramid] Definition: In this next step, we can prepare a series of 3d color images with sizes varying by a power of 2 The raw input data is the Level 0 representation.

[Nx Ny Nz ]=Level 1 Representation

[Nx/2 Ny/2 Nz/2 ]=Level 2 Representation

[Nx/4 Ny/4 Nz/4 ]=Level 3 Representation

[Nx/8 Ny/8 Nz/8 ]=Level 4 Representation.

These derived representations can be computed from the original raw data or sequentially from each higher level. However, since the number of points per voxel would have to be stored we recommend computing all levels directly from the raw data

As noted earlier, it is not necessary that successive level representations have sizes varying by a factor of two. Successive images may in fact vary by any selected factor and successive pairs of successive levels may be associated by different factors (i.e. the Level 2 representation may be smaller in each dimension by a factor of 3 than the Level 1 representation although the Level 3 representation is smaller than the Level 2 representation by a factor of 4.)

For 3d color images with significant overlap, all the regularly sampled images together generally may require fewer points than the original total depending on the amount of scan overlap. For example, if we count the full number of dense-voxels at each representation level, the following estimate is obtained

1+⅛+1/64+1/512˜=1.14

indicating that the approximate voxel-based overhead for all coarser images than the highest sampled resolution image is about 14%. In many cases, the Level 1 representation contains substantially fewer occupied sparse-voxels than the number of points in the raw image data. As a result, the present invention provides an equivalent perceivable data representation with vastly superior indexing, processing, and drawing properties than without this operation. We refer to the 3d color image set, or stack of 3d color images, as a 3d color (image) pyramid at this point. The term pyramid is used to signify to analogy to 2d image processing pyramids such as those by P. Burt. Note that the multiple levels allow direct neighborhood lookup, progressive level rendering, and various inter-level lookup processes.

We have also implemented another type of progressive rendering sequence based on trees. This method is superior to what we mention here, but it is significantly more complicated.

Step 700. Basic 3d user interaction and display techniques: When displaying 3d color image on a 2d color screen, we wish that each point should project to a circle that would occupy as large as a 2d spot in the 2d image plane that a sphere of radius ‘s’ in 3d would occupy.

For each 3d color pixel, we can compute the distance from the eye point's plane using the following transformation sequence:

[x′y′z′]=[R]([xyz]−[p])+[t]

where [p] is the view pivot, [R] is a 3×3 orthonormal rotation matrix, and [t] is offset vector to the eye point. Then the perspective/orthographic pixel coordinates (u, v) are defined to within a scale and offset as the following:

u=x′/z′ perspective (u=x′ orthographic)

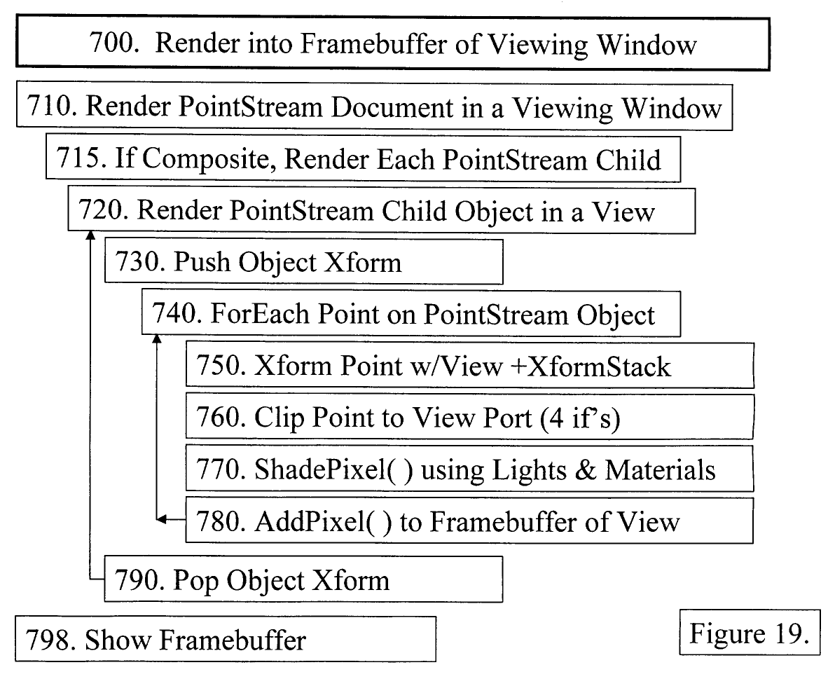

v=y′/z′ perspective (v=y′ orthographic)

where z′ is the distance from the eye point plane to the 3d color pixel. Therefore, for orthographic projection displays, we need for each point to a circle of radius ‘s’ to guarantee no holes in the image (scaled the same as the x′→u transformation). These equations are the basic transformation math for Step 750 in FIG. 19.

For perspective projections, it is theoretically necessary to render each point with the circle radius of (s/z′). Therefore, we see that as z′ gets smaller in magnitude, the size of the points must grow to maintain proper image fill characteristics.

Size-Depth-Product Invariance

For a 3d color image with a fixed point spacing ‘s’, the 2d pixel size of a point can be computed by dividing the point's Z value into an invariant quantity we call Q(s):

H_{—}2d=Q/Z.

To be specific, if a 3d separation distance ‘s’ is viewed at a distance Zfar, the separation subtends an angle where θfar

tan(θfar)=s/Zfar

When the same 3d separation is viewed a closer distance Znear, then it subtends an angle θnear where

tan(θnear)=s/Znear

We model the 2d computer screen distance as Zscreen, and we denote the screen projection of the cloud invariant screen separation distance ‘s’ as Hnear when ‘s’ is at Znear and Hfar when ‘s’ is Zfar. Therefore, the following additional relationships hold:

tan(θfar )=Hfar/Zscreen

tan(θnear)=Hnear/Zscreen

By combining the expressions above, we have a fundamental relationship we call the pixel Size-Depth Product invariant Q(s)

Size-Depth Product Invariant=Q(s)=Hnear*Znear=Hfar*Zfar=H*Z

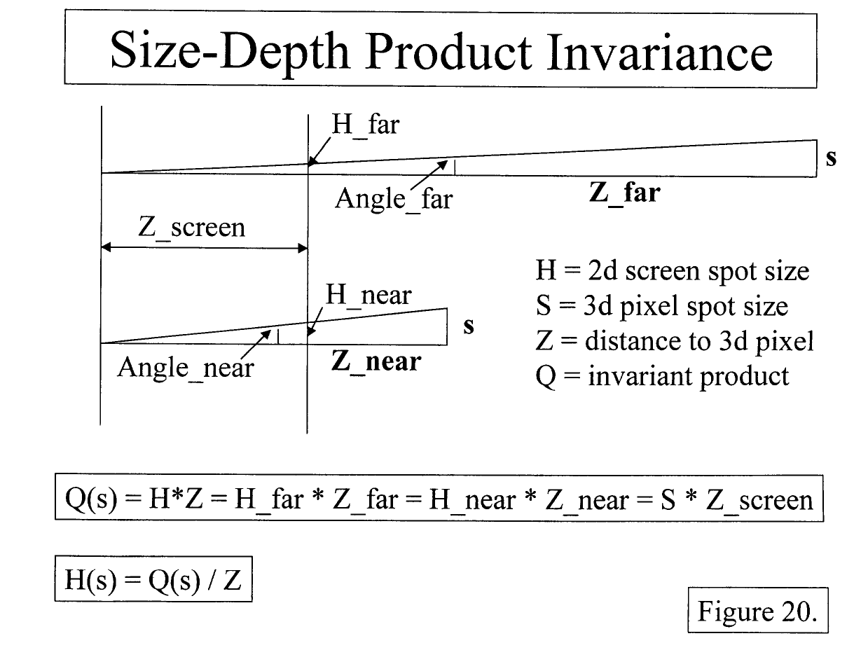

This quantity Q(s) is the fundamental quantity that determines how large to make a 3d pixel on the 2d screen during the rendering process. The units of Q(s) is pixel*mm. FIG. 20 shows the relationship between these quantities.

An Aside on OpenGL Implementation Issues

For a 3d color pixel with a normal, the draw loop for a 3d color image is as follows for an OpenGL (i.e. current de facto standard) implementation:

glBegin(GL_POINTS);
for( i = 0 ; i < Number_Of_Points; ++i)
{

glPointSize( PointSize(xyz[i],View) );
glNormal3fv( nvec[i] ); // optional
glColor3ubv( rgb[i] );
glVertex3fv( xyz[i] );

}
glEnd( );

The primary innovations of the present invention involve the sampling methods, the pyramid generation and organization, as well as the customized PointSize( . . . ) function, smoothing functions, and other processes. We note that vertex position, normal direction, and color are standard vertex attributes for conventional polygon & point graphics. Typically, vertex array methods are provided by graphics libraries to accelerate the rendering of such data when the data are polygon vertices. However, no standard graphics libraries currently include “pointsize” as an “accelerate-able” vertex attribute since standard graphics libraries are polygon or triangle oriented. This invention includes the concept that a view-dependent pointsize attribute is a very useful attribute for point-based rendering that can be incorporated directly within any standard graphics library's existing structure with only a very limited change in the API (application programmer interface), such as Enable( ), Disable( ), and SetInterPointDistance( ). This concept allows applications to remain compatible with existing libraries for polygon rendering while providing an upward compatible path for a simpler rendering paradigm that is potentially faster for complex objects and scenes. It certainly significantly alleviates modeling pipeline problems when the modeling dataflow starts with Xyz/Rgb scanner data because many functions performed by people can be eliminated. In today's world, graphics is easy but modeling is still quite difficult.

Specifically, we note that after many iterations in graphics technology, there are now 2 primary standards still evolving: one is OpenGL and the other is Direct3D. Phigs, PEX, and graPhigs are basically dead. OpenGL and Direct3D both are severely limited in current and previous standards with respect to their ability to realize an optimal 3d color image display capability as described for this invention. Rather than provide the functions necessary for our applications, Microsoft, OpenGL.org, Nvidia, & ATI have moved in the direction of programmable vertex shaders and programmable pixel shaders.

(1) OpenGL points are rendered as boxes in OpenGL's most efficient method (the only acceptably efficient option), but circles in OpenGL are extremely inefficient. Circles are not inherently inefficient from a mathematical point of view since simple bitmaps could be stored for all 3d color pixels of size up to N×N 2d pixels and then “BitBlitted” to the screen. The amount of memory is minimal and the modification to the generic OpenGL sample code implementation is not severe, although hardware assist would require more work. When lighting calculations are not involved, our current generic software implementation of circles and ellipses is faster than OpenGL's square pixels.

(2) OpenGL points don't support front and back shading (GL_FRONT_AND_BACK) as well as not supporting GL_BACK either. There is no reason not, too, but the original implementers did not foresee the needs of this data structure.

(3) The glPointSize( ) call can be very expensive in some OpenGL implementations. Speed enhancements are obtained by minimizing the number of calls.

(4) Furthermore, OpenGL computes the value of z′ explicitly inside the OpenGL architecture since the “View” has already been set up separately when one is drawing. This value is not available at all in the calling application even though it is known during the draw. OpenGL could be enhanced with a glPointSize3d( ) command or with some query procedures, or with specialized drawing modes.

(5) glPointSize( ) cannot be used as effectively as theoretically possible with glDrawArrays( ) and glVertexPointer( ) in the current and past versions of OpenGL since PointSize is not used in conventional graphics as we use it here and is not a property tied to the glDrawArrays( ) capability.

Direct3D/DirectX from Microsoft is another option for implementing a draw loop for our 3d color images and pyramids. The function IDirect3DDevice7::DrawPrimitive( ) using the D3DPT POINTLIST d3dptPrimitiveType is the similar procedure to glDrawArrays( ) and the efficiency it can provide, but seems to have the same pointsize attribute limitation. Game Sprockets and other software is available on the Mac platform. On Linux, Xlib points can be drawn directly just as with Win32 GDI, but the data path for the fastest T & L (transform and lighting) is the primary consideration on any platform.

PointSize Per Point-Group Method

A part of the present invention includes the packaging of points in ways to minimize the number of glPointSize( ), or equivalent, operations in current graphics library implementations. One way to do this involves binning groups of 3d color pixels into uniform groups of a single pointsize. This then allows one glPointSize( ) command for each group rather than for each point as might be required in the optimal quality scenario.

glPointSize(PointSize(groupxyz, View));

glBegin(GL_POINTS);

glEnable(GL_COLOR_MATERIAL);

| | |
|---|---|
| For( i = 0 ; i < Number_Of_Points; ++i ) | // this loop could now be done |
| { | // by glDrawArrays( ). |

glNormal3fv( nvec[i] );
glColor3ubv( rgb[i] );
glVertex3fv( xyz[i] );
}
glEnd( );

Single Color Per Point-Group Method

Similarly, points could also be grouped in terms of similar normals or similar colors rather than in terms of similar point spacing. Although this complicates the data structuring issues, allowing contingencies for spatial grouping, normal grouping, and color grouping allows the Normal and/or Color command(s) to be removed from the “draw loop” for such groups. For an original object with only a few discrete colors, one can partition that original object into one object for each color and eliminate per point colors entirely.

A part of this invention includes that the point display loop should be highly customized for maximum rendering speed. Since many generic CPU chips now support 4×4 matrix multiplication in hardware, especially in at least 16-bit format, there are numerous methods of display loop optimization. Note that we do not propose tree structures or texture mapping constructs for the main point display loop. This is quite different than almost all the previous literature. The display speed of this invention can therefore be significantly higher than other known published methods in the oversampled scene geometry case simply because the “fast-path” in the graphics hardware dataflow need not include most of the machinery used in conventional graphics.

Steps 216, 320, and 380: O(N) time “On the fly” normal estimation: Based on our 3d color image data structure, this invention allows the computation of 3d color pixel normal vectors to be done “on the fly” during the reception phase of the 3d color image data transmission when it is streamed over a network channel. There is an implicit render quality and client memory tradeoff tied to this bandwidth-reducing feature. Other methods, for example, might view highest-available-resolution point-normal-estimates as a fundamental data property for any lower resolution representations whereas color is sometimes viewed as an optional parameter. With our bias toward a fundamental joint representation of color and shape, we can view the point-normal-vector field as an optional parameter since “reasonable” quality normals can always be estimated from the point data. If the data is sent in an unstructured form or a tree-structured form, the complexity of normal computation is O(N log N ). With our 3d color image method, the complexity of normal computation involves one O(N) operation pass using a pre-initialized voxel array followed by O(1) computation over the N points yielding an O(N) operation aside from the voxel array initialization cost. Hardware methods for clearing an entire page of memory at once can make the voxel initialization cost minimal, or at least less than O(N), yielding an O(N) method compared to other O(N log N) methods.

Normal Computation Given Points in a Neighborhood

Our basic method of normal computation is a simple non-parametric least squares method that involves simple 3d color image neighborhood operations in the implicit 3×3×3 voxel window around each 3d color pixel. The method can also be implemented for 5×5×5 windows or any other size, but the 3×3×3 kernel operator is the most fundamental and one can mimic larger window size operations via repeated application of a 3×3×3 kernel. With up to 26 occupied voxels in a point neighborhood, each point/voxel in the neighborhood contributes to the six independent sums in the nine elements of a 3×3 covariance matrix [Cov]. Any neighborhood containing between 3 and 27 non-collinear points yields a surface normal estimate that is ambiguous only with respect to (+) or (−) sign.

SumXX=Σ_{—}i(X_{—}i*X_{—}i)

SumYY=Σ_{—}i(Y_{—}i*Y_{—}i)

SumZZ=Σ_{—}i(Z_{—}i*Z_{—}i)

SumXY=Σ_{—}i(X_{—}i*Y_{—}i)=SumYX

SumYZ=Σ_{—}i(Y_{—}i*Z_{—}i)=SumZY

SumZX=Σ_{—}i(Z_{—}i*X_{—}i)=SumXZ

The 3×3 covariance matrix [Cov] is then diagonalized via one of several different available eigenvalue decomposition algorithms. Only the unit-normalized eigenvector e-min associated with the minimum eigenvalue λ-min of the covariance matrix is actually needed for the point's normal. The definition of eigenvalue implies the following statements:

[Cov]*e-min=λ-min*e-min

λ-min=Mean−Square-Deviation of the Points from a Plane

At this stage of the process, the computed normal is ambiguous with respect to sign: that is, we don't know if the normal vector is vec_n or -vec_n. Whereas correct topological determination of all normals relative to one base normal can be done in theory given certain sampling assumptions, it is much simpler to just evaluate a sign discriminant and flip the normal direction as needed so that all 3d color pixel normals are defined to be pointing in the hemisphere of direction pointing toward the eye. This causes all points to be lit. [OpenGL could have also solved this problem if GL_FRONT_AND_BACK worked for points.] The discriminant is a simple inner product that can be performed using host CPU cycles or graphic card processor cycles:

The Normal Sign Discriminant Computation:

2 adds, 3 multiplies, assignment, if, and 3 conditional sign flips.

discrim=R[0][2]*I+R[1][2]*J+R[2][2]*K

if(discrim>=0) draw point using (I, J, K) with Lighting model

else draw point using (−I, −J, −K) with Lighting model.

In addition, this invention includes this method for computing point normal vectors on the fly given a 3d color image description that contains no normal information whatsoever. Note that the 3×3×3 neighborhood of point has 2ˆ (27) different possibilities in general, or about 134 million different combinations. With the 3d color images that are currently available to us, it is generally true that only a small number of these point configurations are encountered in practice in a given implementation of this set of algorithms. Therefore, the point normal could be computed via a lookup table if sufficient memory could economically be dedicated to the this task for whatever given accuracy is desired. Other methods exist that can map a 27-bit integer into the appropriate pre-computed normal vector since many normal vectors are the same for various configurations in the 3×3×3 neighborhood.

Step 350. Integral Smoothing Options for Points, Normals, Colors: Although it is not a necessary aspect of the methods of this invention, it is possible to smooth the points or the normal vectors or both at 3d color pixel locations in either the circumstance of (1) pre-computed normal vectors, or (2) computation of normal vectors “on the fly” given our 3d color image structure as described above in Method 6. The point locations or the normal vectors of the neighboring points in the 3×3×3 window (or both) can be looked up and averaged making both smoothing operations O(N). In contrast to point averaging, general normal vector averaging requires a square root in the data path that would require special attention to avoid potential processing bottlenecks if this option is invoked. For very noisy data, this can be an invaluable option. It can also be needed to overcome the quantization noise that is causes by the truncation of the sub-voxel positions during run-length encoding.

Step 430. 3d Color Image/Xyz/Rqb Pointstream Compression/Codecs: This invention also covers all methods of compressing the various forms of 3d color images that allow for fast decompression of the pointstream. While all possible methods of compression are beyond the scope of this patent document, it is clear that a variety of possible data compression methods can be used to encode the spatial and the color channels of the 3d color image. In addition, attribute information could also be compressed. Initial studies show that the net information rate is significantly less than the actual data rate for a transmitted or stored color image. We have empirical evidence that approximately 2-15 bits per 3d color pixel is achievable on many types of 3d color image data (Xyz/Rgb), and we believe that it is possible to do better.

The current preferred embodiment of the Pointstream Codec (coder/decoder) involves a hybrid scheme. The raw scanner data forms the initial pointstream which generally contains significant overlap of many scanned areas. This pointstream is sampled with an appropriate sampling grid that is entirely specified by nine (9) numbers: Xmin, Ymin, Zmin, dx, dy, dz, Nx, Ny, Nz. One can think of the sampling grid as mathematical type of scaffolding around the data. The sampled pointstream is then run-length encoded (RLE) using a full 3d run length concept described below. We have achieved excellent results by further encoding the RLE data via a general compression tool.

RLE

The algorithm we are about to describe varies significantly from other known RLE type algorithms. First, a “run” is conventionally thought of as a string of repeated symbols, such as

“aaaaabbbcccccc”

which you would say is a run of 5 a's followed by a run of 3 b's, followed by a run of 6 c's. In a data block notation, the run length encoding of the above string would be the following:

|5|a|3|b|6|c|

We refer to this as a “fill” run since it fills the output with the given run lengths. The compression literature seldom refers to a string such as

“abcdefghijklmnop”

as a run of 16 characters starting at position 0 with a start value of “a” and an end value of “p” and a linear interpolant prescribed on the ascii decimal equivalent values between the start and the stop values. Such a concept would only be popular e.g. in geometric algorithms where linear interpolation of values is commonplace. To be explicit, a conventional RLE encoding of the above string would be the following:

|1|a|1|b|1|c|1|d|1|e|1|f|1|g|1|h|1|j|1|k|1|l|1|m|1|n|1|n|1|o|1|p|

Of course, real text-based RLE algorithms are not this dumb and allow “literal” runs and “fill” runs to both be encoded efficiently in the same data stream. A literal run method would have a structure such as the following:

|A code that says a literal string is coming|“abcdefghijklmnop”|

This invention's 3dRLE encoding of the above string would be much shorter:

|0|16|“a”|“p”| (run starts at 0, is 16 units long, varies from a to p)

This makes sense if you are aware that “a” is represented in the computer as an integer and “b” is an integer that is either one greater (or one less than) “a”, and so on. Hence, this is a linearly interpolated run length encoding, or LIRLE.

A full example 3d run length encoding (3dRLE) algorithm is given below, but first we give a simple outline of the idea using the notions of rows, columns, and towers (of sparse-voxel blocks):

(1) Establish the logical grid structure of the voxel grid the stream is embedded in.

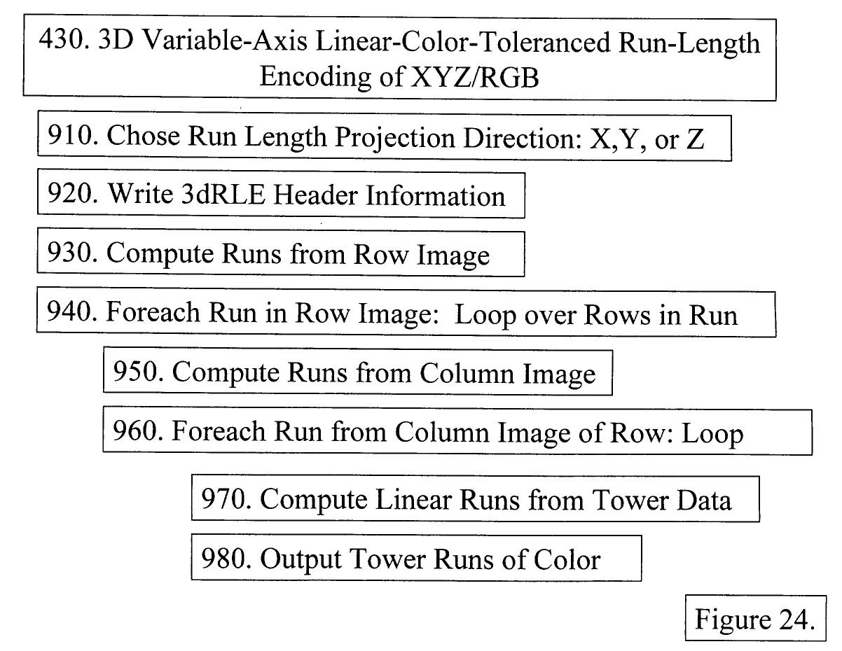

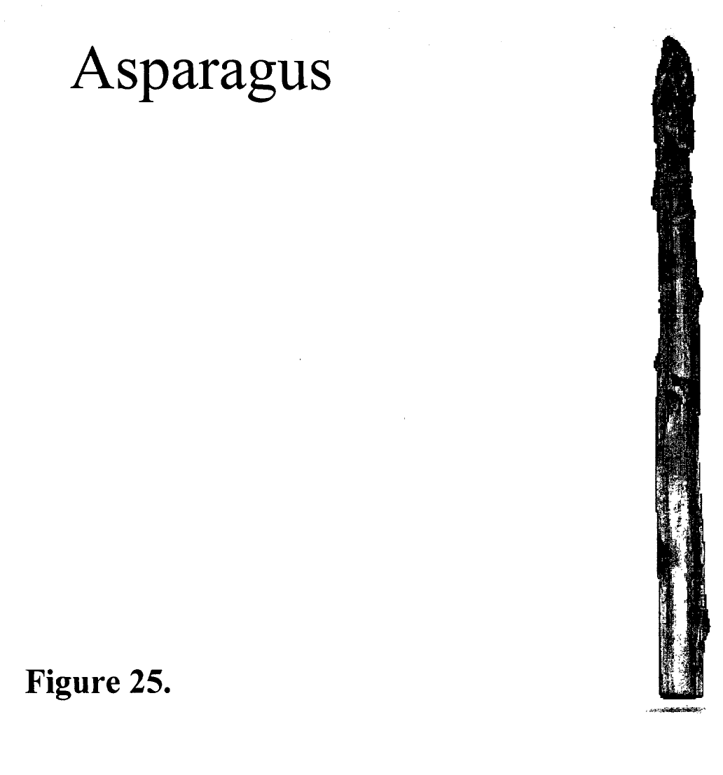

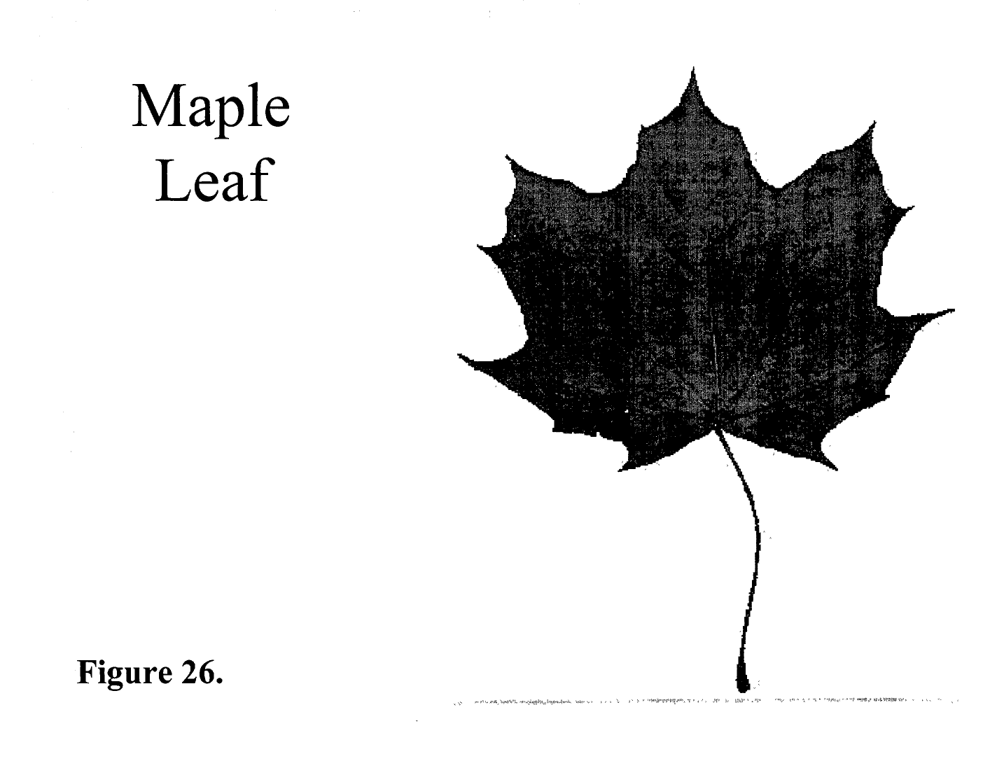

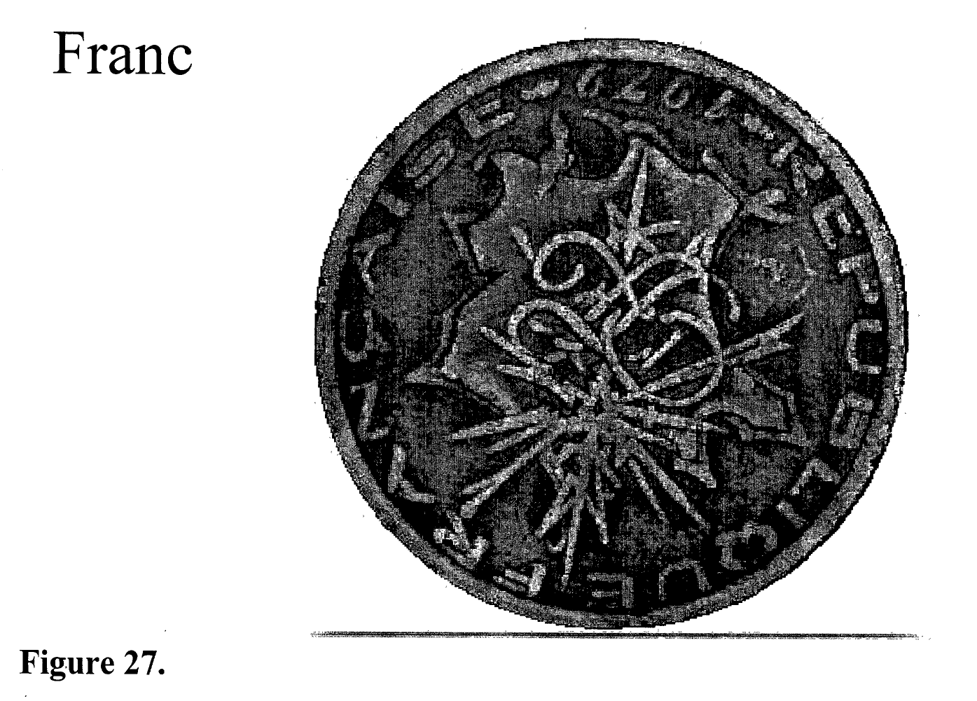

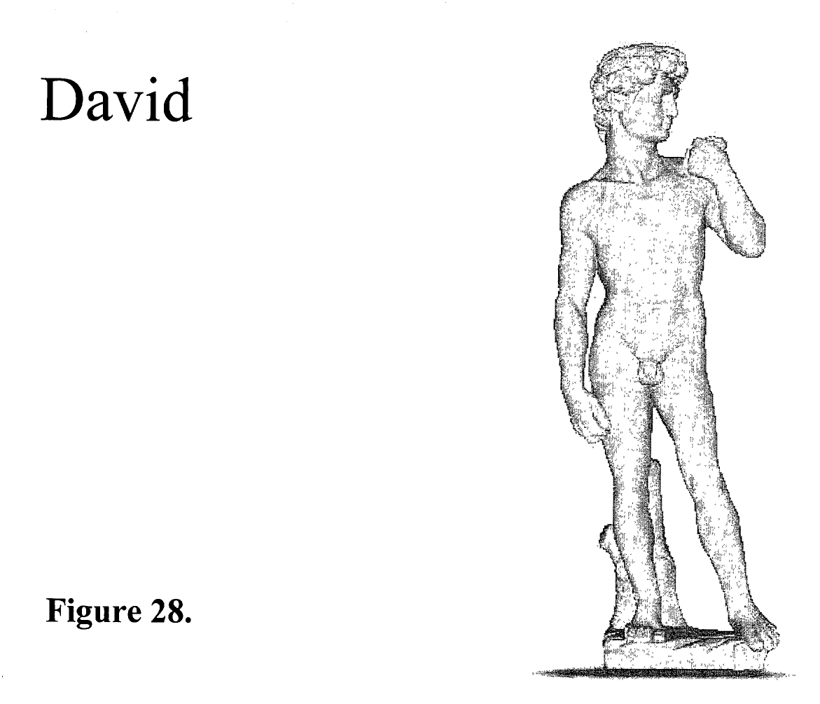

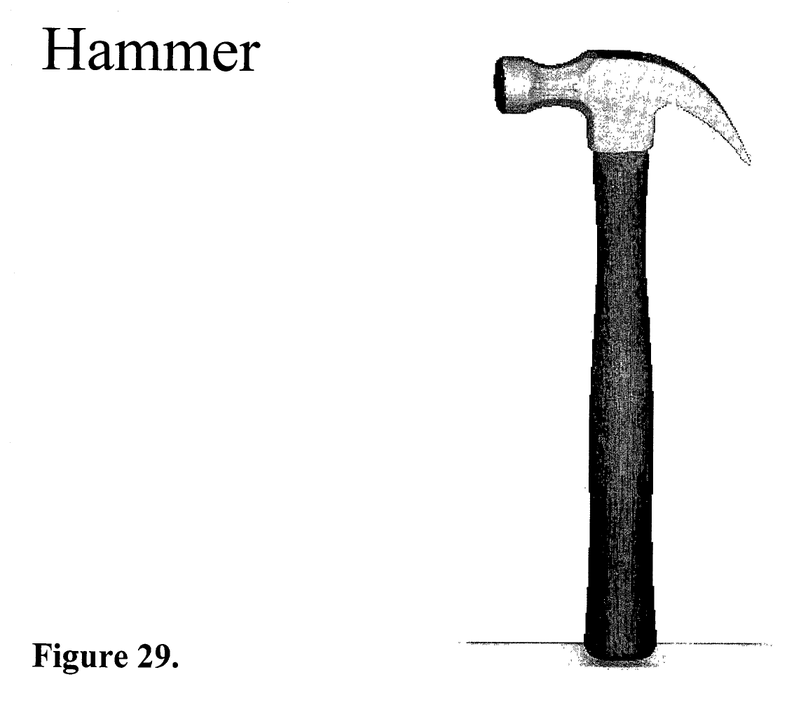

(2) Establish the Projection Direction. [Step 910][FIG. 24]

(3) Establish a Row Structure Vector and a Row/Column Binary Image Structure.[Step 930][FIG. 24]

(4) RLE on the Binary Row Structure.[Step 940][FIG. 24]

(5) RLE on the Binary Column Structure of a Given Row.

(6) LIRLE on the 16-bit Colored Tower of Runs [Step 960][FIG. 24]

(7) Use Short for Offset, Byte for Run Length.

(8) Allow Color Error with Tolerable Level.

FIG. 24 shows the arrangement of the above steps.

Full Details

Here is a full implementation. Note this encoder only contains fill logic and no literal logic. A final preferred embodiment is very likely to allow for literal runs.

A Full 3dRLE “Fill Type” Encoding Algorithm

PointStreamEncoder *Encoder=new PointStreamEncoder( );

Encoder->WriteInteger(iMagic); //numeric id for format type

Encoder->WriteFloats(Xmin, Ymin, Zmin);

Encoder->WriteFloats(dx, dy, dz);

Encoder->WriteShorts(Nx, Ny, Nz);

Encoder->WriteInteger(NumberOfOccupiedVoxels);

Encoder->WriteByte(iType ); //0, 1, 2 for X, Y, Z primary projection

Encoder->WriteByte(kRow[iType]);

Encoder->WriteByte(kColumn[iType]);

Encoder->WriteByte(kTower[iType]);

int nRows=n[kRow];

int nColumns=n[kColumn];

int nTower=n[kTower];

Encoder->WriteShort(nRows);

Encoder->WriteShort(nColumns);

Encoder->WriteShort(nTower);

unsigned char *Rowlmg=new unsigned char [nRows];

unsigned char *RowCollmg=new unsigned char [nRows*nColumns];

unsigned char *TowerImg=new unsigned char [4*nTower]; //color

memset(RowImg, 0,sizeof(unsigned char)*nRows);

memset(RowColImg,0,sizeof(unsigned char)*nRows*nColumns);

memset(TowerImg,0,sizeof(unsigned char)*4*nTower); //rgb color

PsByteRun *pRowRunArray=new PsByteRun [nRows];

PsByteRun *pColRunArray=new PsByteRun [nColumns];

PsColorRun *pTowerRunArray = new PsColorRun [n Tower];
//
// Build RowImg and RowColImg for Later RLE Computations
//
for( iRow=0; iRow < nRows; ++iRow )
{

bool isRowNeeded = false;
for( iColumn=0; iColumn < nColumns; ++iColumn )
{

bool isColNeeded = false;
for( iTower=0; iTower < nTower; ++iTower )
{

idx = (iTower*mTower + iColumn*mColumn + iRow*mRow);
if( voxel[idx] >= 0) { isRowNeeded = isColNeeded = true; break; }

| } | |
|---|---|
| if( isColNeeded) | { RowColImg[ iColumn + iRow*nColumns ] = Marker; } |

| | |
|---|---|
| else | { RowColImg[ iColumn + iRow*nColumns ] = 0; } |

| } | |
|---|---|
| if( isRowNeeded) | { RowImg[iRow] = Marker; } |

| | |
|---|---|
| else | { RowImg[iRow] = 0; } |

}
//
// Do Run Extraction from Binary Row Image and Process
//
int nRowRuns = Encoder->ComputeExactByteRuns(pRowRunArray,
RowImg,nRows);
Encoder->WriteShort( nRowRuns );
for( iRowRun=0; iRowRun < nRowRuns; ++iRowRun )
{

| | |
|---|---|
| int iRowStart | = pRowRunArray[ iRowRun ].StartIndex( ); |
| int nRowRunLen | = pRowRunArray[ iRowRun ].RunLength( ); |

Encoder->WriteShort( iRowStart );
Encoder->WriteByte(nRowRunLen );
//
// Process this Run of Rows
//
for( iRow=iRowStart; iRow < iRowStart + nRowRunLen; ++iRow )
{

int nColRuns = Encoder->ComputeExactByteRuns(

pColRunArray,&RowColImg[iRow*nColumns],nColumns);

Encoder->WriteShort( nColRuns );
//
// Loop over set of column runs across this row
//
for( iColRun = 0; iColRun <nColRuns; ++iColRun )
{

| | |
|---|---|
| int iColStart | = pColRunArray[ iColRun ].StartIndex( ); |
| int nColRunLen | = pColRunArray[ iColRun ].RunLength( ); |

Encoder->WriteShort( (short) iColStart );
Encoder->WriteByte( (unsigned char) nColRunLen );
//
// Process each grid element in this Run of Columns
//
for( iColumn=iColStart;iColumn<iColStart+nColRunLen; ++iColumn )
{

// Process Tower into Marker Array
//
for( iTower=0; iTower < nTower; ++iTower )
{

idx = (iTower*mTower + iColumn*mColumn + iRow*mRow);
if( (k = voxel[idx]) >= 0 )
{

TowerImg[(iTower<<2)+0] = rgb[k][0];
TowerImg[(iTower<<2)+1] = rgb[k][1];
TowerImg[(iTower<<2)+2] = rgb[k][2];
TowerImg[(iTower<<2)+3] = Marker;

}else
{

memset( &TowerImg[(iTower<<2)+0] ,0,4);

}

}
//
//Compute Occupied Color Runs in this Tower
//
int nTowerRuns = Encoder->ComputeAproxColorRuns(

pTowerRunArray, TowerImg, nTower, iColorPrec);

Encoder->WriteShort( nTowerRuns );
//
// Loop over all Tower Runs
//
for( iTowerRun = 0 iTowerRun < nTowerRuns; ++iTowerRun )
{

```
  int iTowerStart = pTowerRunArray[ iTowerRun ].StartIndex( );
int nTowerRunLen = pTowerRunArray[ iTowerRun ].RunLength( );
  startRGB15 = pTowerRunArray[ iTowerRun ].Start15BitColor( );
stopRGB15 = pTowerRunArray[ iTowerRun ].Stop15BitColor( );
Encoder->WriteShort( iTowerStart );
  Encoder->WriteByte( nTowerRunLen );
Encoder->WriteShort( startRGB15 );
Encoder->WriteShort( stopRGB15 );
```

}
Encoder->WriteByte( zTerminate );

}
Encoder->WriteByte( zTerminate );

}

Encoder->WriteByte( zTerminate );

}
Encoder->WriteByte( zTerminate );

}
Encoder->WriteByte( zTerminate );
Encoder->WriteInteger( m_numbytes ); // validation count
Encoder->WriteInteger( m_maxbytes );
Encoder->WriteInteger( EndOfPointStream );

The decoding algorithm does the reverse of this process. This encoding algorithm is a potentially “lossy” algorithm, depending on the selection of the iColorPrec variable.

The quantity iColorPrec determines the color precision, or the color error level. It can be set in the range 0 to 255, but a value of 8 or less is recommended and typical. The current embodiment uses 16-bit colors instead of 24-bit. If iColorPrec is greater than 0, this method makes small color errors and it loses sub-voxel accuracy. If iColorPrec is set to zero (0), the encoding of the sampled color data will be lossless (note though that the sub-voxel positioning data is still lost).

One of the key benefits of this approach is that it leaves almost all the positional information (i.e. spatial information) in an implicit form. We only explicitly state the start address of a row, the start address of a column, and the start address of a tower. In the output of this encoder, the row and column starts are very sparse so almost all the spatial information is written in the tower start addresses. Note that we choose the tower direction based on the direction that will give us the fewest number of tower start addresses. So while other methods are possible, we feel that 3dRLE is at least one reasonable and inventive thing to do.

Step 440. Generic Text Compression PostProcessor of the 3dRLE Data

If there is any redundancy in a byte stream of any type, a generic text compression algorithm can often discover this redundancy and compress the input bytes into a smaller set of encoded bytes. Most PC users are familiar with the ‘WinZip’ utility and most Unix or Linux users are familiar with the ‘gzip’ utility. The reason that these utilities can compress files is that files are seldom random streams of bytes with no inherent structure. Experienced users, for instance, know that if you zip/compress a file twice, the second compression application will very rarely ever be able to improve on the first pass of compression. In a sense, good compression algorithms generate nearly random output streams. And it is a fact that a “perfectly” random output stream cannot be compressed because there is no structure to take advantage of. To be precise about what we mean by “random,” it is helpful to introduce some basic concepts from information theory.

From an information theoretic point of view, we say that the “self-information” of an event X is given by

I=−log 2 (ProbabilityOf(Event X))

If there are 2ˆ m events in an ensemble of events that are all equally likely with probability 2ˆ (−m), then the self-information of any given event is m bits. The entropy of an ensemble of events is given by

H=−Σ_{—}iP(X_{—}i)log 2(P(X_{—}i))

Again, if we have 2ˆ m equiprobable random events in an ensemble of events, then the entropy of the ensemble is m bits. Another point to be made is that a compression algorithm can only be optimized with respect to an ensemble of possible inputs. 2d static imagery and time-varying 2d imagery are well known ensembles that have received a huge amount of attention over the last 30 years. Xyz/Rgb pointstreams have only existed for the last 8 years and the type of 3d color image data that we create from those pointstreams is novel so there is a lot to learn about the information theoretic properties of this type of data.

Step 440 Implementation

The field of lossless data compression, also known as text compression, addresses the problems of compressing arbitrary byte streams and then recovering them exactly. Currently, the PPM family of codecs are the most effective generic codecs known. (PPM stands for “Prediction by Partial Mapping”). PPM codecs are not as widely used as other codecs because prior to Effros [2000], PPM codes had worst case O(Nˆ 2) run times. The LZ (Lempel-Ziv) family and the BWT (Burrows-Wheeler transform) family of codecs are more popular since their run-time performances are O(N), and the decoders are quite fast. Currently, BWT-based codes are increasingly popular owing to their ability to outperform entrenched standards such as Winzip and gzip. We therefore decided to combine the 3dRLE output stream with a generic lossless text encoder to remove the redundant structure present in its byte stream thereby compressing the data into a fewer number of bits. This approach turns out to be surprisingly successful. The best way to view the combination is that we are actually 1D run-length encoding our 3D run-length encoding followed by the optimal Huffman encoding.

Our current choice for generic lossless compression is the bzip2 codec by Julian Seward of the UK. Several references are given above. Some information is included in the following quotes from the documentation:

“bzip2 is a freely available, patent free, high-quality data compressor. It typically compresses files to within 10% to 15% of the best available techniques (the PPM family of statistical compressors), whilst being around twice as fast at compression and six times faster at decompression. . . . bzip2 is not research work, in the sense that it doesn't present any new ideas. Rather, it's an engineering exercise based on existing ideas.”

“bzip2 compresses files using the Burrows-Wheeler block-sorting text compression algorithm, and Huffman coding. Compression is generally considerably better than that achieved by more conventional LZ77/LZ78-based compressors, and approaches the performance of the PPM family of statistical compressors.”

The implementation of the above sparse-voxel 3drle/bzip2 algorithm has yielded excellent compression ratios. The following table expresses some of the results:

| | | Compressed | | | |
|---|---|---|---|---|---|
| | | PointStream | Com- | Number | Bits per |
| | Ascii | (Quality = | pression | of Color | Color |
| Object | Xyz/Rgb | 200) | Ratio | Points | Point |
| Asparagus | 53521 kB | 280 kB | 191:1 | 193 kcP | 11.6 bpcp |
| Maple leaf | 29607 kB | 76 kB | 389:1 | 67 kcP | 9.0 bpcp |
| Monkey | 32603 kB | 85 kB | 383:1 | 106 kcP | 6.4 bpcp |
| Franc | 13948 kB | 531 kB | 26.3:1 | 262 kcP | 16.2 bpcp |
| Hammer | 133498 kB | 69 kB | 1935:1 | 63 kcP | 8.8 bpcp |

Table 1. Compression Results for Hybrid 3dRLE/Bzip2 Embodiment of Invention. These numbers result from processing the complete data set as a single batch of data. No subdividing is done. These results apply only to Xyz/Rgb data. Normals are not considered.

These results appear to be better than any other reported technique known at this time for this type of 3d color data. If we tentatively place our lower and upper nominal performance bounds at 2 to 18 bits per color point, we are essentially representing data usually requiring 3 floats (12 bytes) and 3 bytes per point (or 120 bits per color point (bpcp)) using on the order of 12 bits per point which is a 10:1 compression ratio. It is very likely that better compression can be obtained owing to the nature of our 3d color image data structure.

Step for Encoding and Storage of Surface normal vectors

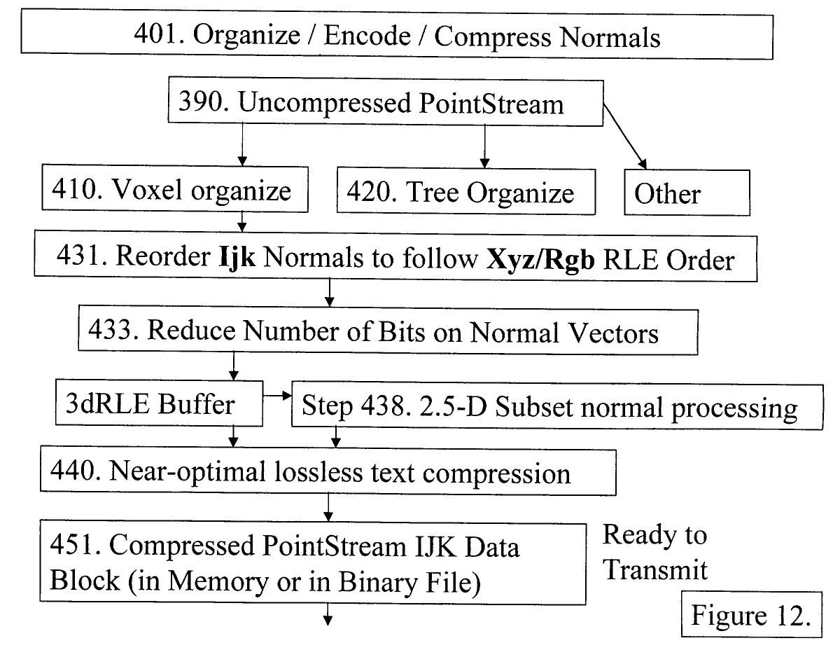

FIG. 12 [Step 401] mentions the encoding of the surface normal vectors (the ljk channel) as a separate channel. The following section describes a normal encoding method that requires some addition partitioning/organization of the 3d color image data.

Our experience is that normals must be encoded as a separate data channel to get reasonable compression.

The 3d color image points generally lie on a surface (2-manifold) of arbitrary shape. As described in the earlier section, the surface-normal-vectors can be computed for each 3d color point of the 3d color image. The most accurate surface-normal-vector for each point can be computed from the highest resolution 3d image, as it has been mentioned in “Method 6:_O(N) On the fly normal estimation” above. For a given 3d color image which forms a surface, the closest points on an image are, generally, also neighbors on the surface that is described by the 3d color image (It should be noted that this is not a necessary condition to the method described here). When the above condition is true, for a smoothly varying surface, the normal of the closest point will also vary smoothly by small angles. When we attempt to compress the normal of the 3d color image, we want to utilize this gradual change or the inherent redundancy in the surface-normal-vector information to give better compression results. In this section, we present our method of compressing surface-normal for the sampled 3d color image.

If the points on the implied sampled surface are adjacent, the well-known concept of delta encoding could allow us to store and compress the change in the surface-normal-vectors rather than the absolute value of the surface normal components. If this change in value is constant, or varies slowly, the repeated data has a better chance to get compressed using conventional techniques. It should be noted that such a surface normal compression method would require a unique surface topology, where the adjacent points in the 3d color image can be easily accessed. However, we do not have a surface topology in a 3d color image, much less a unique way to traverse the adjacent points on the surface. If one can find a way to traverse the points such that adjacent points are met one by one and the traversal directory covers the relevant surface, one can get a good compression of the surface-normal by using the redundancy in data. Unfortunately, this requires storing the order of the point indices as they are traversed, along with the surface normal data. This index overhead itself will need storage of ˜2-4 bytes per point depending on the total number of 3d color image points.

Our Method : Encodinq and Compression of Surface-normal-vectors

We have invented a novel method to compress the surface-normal-vectors of an unstructured set of 3d color points. In this method, the high resolution 3d color image is spatially subdivided into smaller regions, such that each such subdivision has a small part of the surface described within 3d color image. We have implemented subdivision through Axis-aligned bounding box (AABB) trees as well as oriented bounding box (OBB) trees. The creation of AABB trees from a given point-set is very well documented in the literature. The idea behind the subdivision is that, within such a subdivision the adjacent points are likely to be together and there is much lower variation in points' surface-normals. This can be measured by calculating the normal cone of points within each subdivision. The normal cone of the set of points is calculated by first calculating the average of all normals. Then we calculate the maximum angle between each point's normal and this average normal. This maximum angle defines the normal cone for the points within subdivision with reference to the average normal. A small normal cone is generally indicative of a comparatively flat surface, whereas, a normal cone greater than 90 degree implies that the surface wraps around within the subdivision, or there are multiple connected components within the subdivision. While the spatial subdivision of a 3d-color image does not guarantee that only the neighboring points on the implied surface will be together, most subdivisions of this type have a small variation in the surface-normal. In fact, we encounter some subdivisions with disjoint surface elements, but there are relatively few of these, if appropriate subdivision is used. The number of times the 3d color image is subdivided is discussed later. This method of building a spatial subdivision is distinctly different from approach taken by Pauly and Gross[2001]. They mention building a surface patch layout for point-sampled geometry. Their method of performing spectral analysis on the resulting patch layout necessitates that the patch has a cone angle smaller than 90 degree. In contrast, we do not have any such constraint with our subdivision. In addition, our method is not likely to work with their patch layout, because it can generate arbitrarily small sized patches in areas where surface-normal varies significantly. We think that using such a patch layout will be very inefficient for compression.

The 3d color points are then sampled within each spatial subdivision independently, similar to the method described earlier in “Algorithm implementation” on page 10. In this method, instead of creating a regular sample grid for the entire 3d color image, we compute the regular sampling grid for each subdivision separately. The subdivision sampling is done by using the same nominal delta value, as has been used to sample the whole regular 3d color image. The sampling yields one point per sparse-voxel element inside the regular subdivision grid. All the subdivisions are then taken together to generate the full 3d color image sample. The resulting image from combining all the sampled points from each subdivision ensures that there is at least one point within s=2*sqrt(3)* max(dx, dy, dz ) of another point in the 3d color image, as discussed in method 8.

Encodinq of 3d Color Image Subdivisions

All subdivisions are stored sequentially to create the full 3d-color image. Within each subdivision, the regular grid has position, color and normal information per sparse-voxel element. The XYZ position, RGB color information is encoded using the same technique as has been described in “Step 400: 3d Color image/Xyz/Rgb Pointstream compression”. The position and color of points in a subdivision are stored using the same order of row, column and tower. The surface-normals are optionally stored in addition to the position and color data. As an alternative, we could store the surface normal in the same order as position and color data of 3d color point, however, we have a special ordering method we term as “wrap-around”, to store the surface-normal.

With this ordering method, we re-order the surface-normal data, such that the proportion of adjacent points that are in a sequence is increased. This ordering mechanism is independent of the position data and we do not need a separate indexing mechanism to store this new order of surface-normal data. A major advantage of storing the points in this format is that, when only a portion of the surface is part of the subdivision and we traverse the 3d grid in this fashion, the majority of adjacent points on the surface are also written in a sequence. While the adjacency is not guaranteed, the majority of points are observed to be in a sequence. As a result, the surface-normal data of most points is similar to their neighbors in the sequence. This fact makes them amenable to better compression.

Details of “Wrap-around” Method

The position and color information from the sparse-voxel array is stored successively, first by row, then by column and then the “tower” direction. We call this “row-column-tower” traversal. The pseudo code for traversing and storing the position and color is:

For each row {

For each column {

For each tower {

If voxel element is occupied

save it.

}

}

}

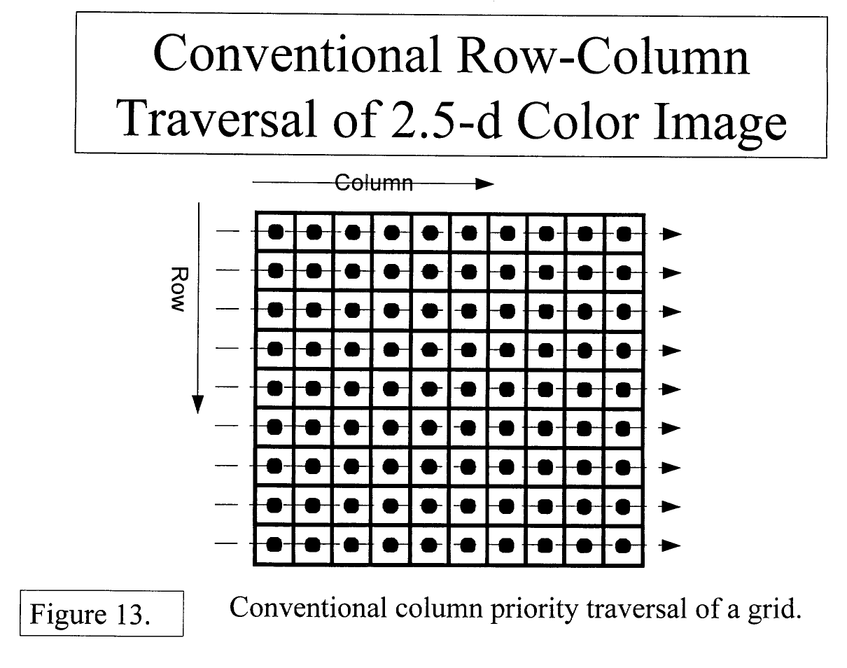

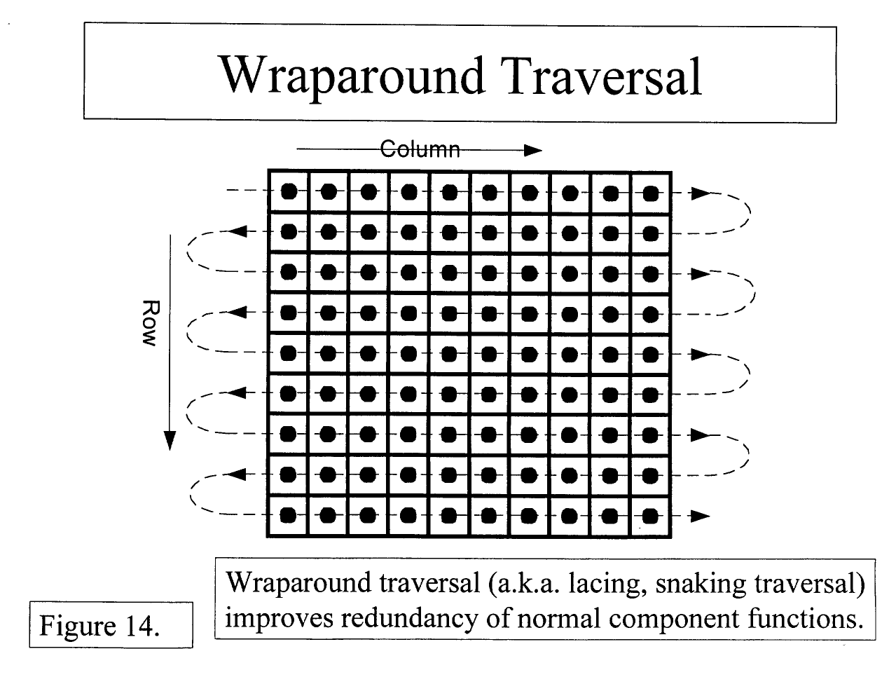

In FIGS. 13 and 14, this algorithm has been explained diagrammatically. For sake of clarity of representation of the traversal sequence on paper, the idea has been shown in a 2.5D voxel array. The 2.5D voxel array shown is also sparsely populated, to be more representative of our sparse 3D voxel array.

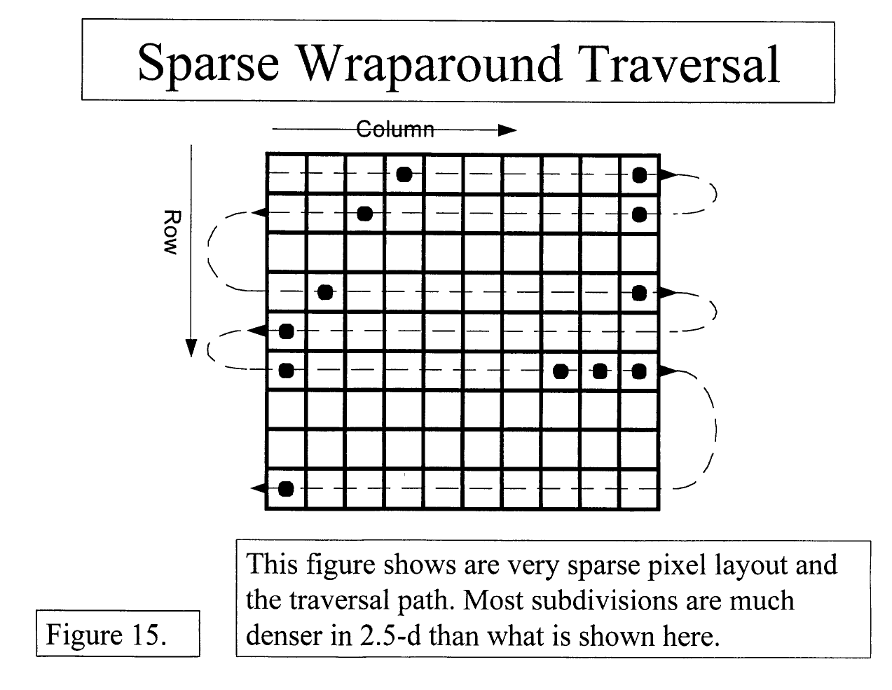

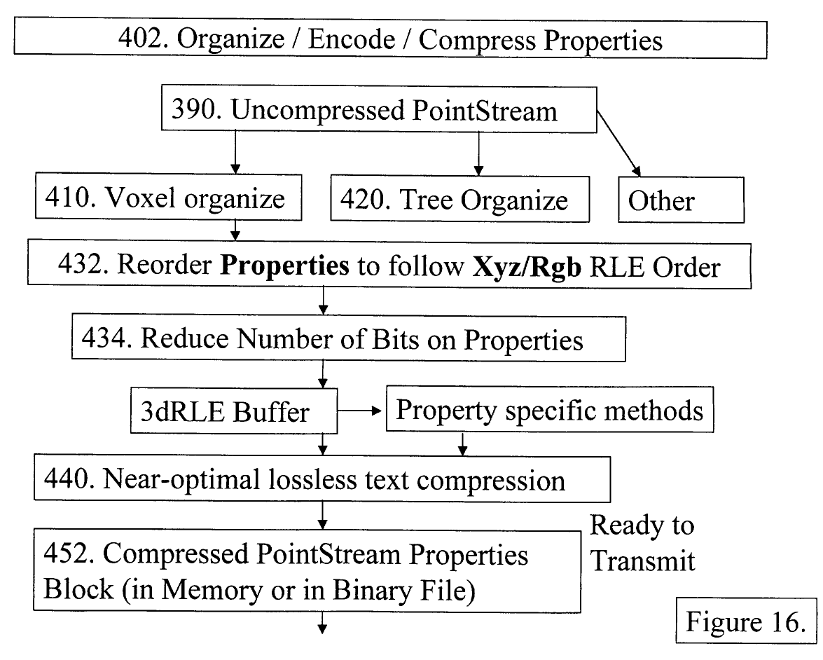

FIG. 15 shows the “wrap-around” format of traversal, where the beginning of the row alternates. The odd rows start at the beginning of the column and the even rows start at the end of the column. This can be extended to 3 dimensions. The pseudo code for the 3D wrap-around method is presented below.

ForwardColumnDirection:=true

ForwardTowerDirection:=true

For each Row

{

If Row is even

Reverse the entire column data
ForwardColumnDirection:=false

Else

ForwardColumnDirection:=true

If ForwardColumnDirection = false

ForwardTowerDirection = !(ForwardTowerDirection)

For each Column
{

If ForwardTowerDirection = false

Reverse the entire Tower data

For each Tower
{

If voxel element is occupied

save it.

}
ForwardTowerDirection = !ForwardTowerDirection

}
If ForwardColumnDirection = false

ForwardTowerDirection = !(ForwardTowerDirection)

}

Steps to Encode and Compress Surface-normal within a Subdivision

In our method, the surface-normal is kept as a vector of unit length in 3d space. This vector is typically represented in the computer as 3 floating-point numbers for a total of 12 bytes. Let us denote this normal N by a 3-tuple (Nₓ, N_{y}, N_{z}) (also denoted sometimes as (I, J, K)). We store only 2 components and one sign bit to recreate the normal N. The method along with pseudo code can be described as follows:

1. Consider the series of surface normal data, that is in the same sequence as the position and color data generated from the regularly sampled subdivision. Re-order the sequence of surface-normal data by the “wrap-around” method.

2. For each surface normal,

If Nz<0.0

Nₓ:=−Nₓ

N_{y}:=−N_{y}

N_{z}:=−N_{z}

Sign bit:=1

Else

Sign bit:=0

3. Only the components Nx, Ny, and sign are stored.

4. Take inverse cosine of the components Nx and Ny in the range [−1,1] and divide by π, to bring the numbers in the range [0,1]. This number is then multiplied by 255, which is the maximum storage capacity of an unsigned byte.

Nₓ:=(a cos(Nₓ)/π)*255

N_{y}:=(a cos(N_{y})/π)*255

5. Now consider the thus transformed series of data for both Nx and Ny separately. For each one of these two series, take a vector of 8 transformed components successively and apply a one dimensional discrete cosine transform (1D DCT). The 1D DCT used here is formed by 8 orthogonal cosine functions, to generate 8 DCT coefficients for set of each 8 normal components. Let there be P number of 3d color points in the subdivision. So there will be J=P (integer division) 8, number of vectors. Let the vector of normal components be Nᵢ^{j}∀jε{0,1, . . . j}, the 1D DCT coefficients DC are a vector of size 8 defined by.

$$D {C}_{i}^{j} = 0.5 {C}_{i} {\sum }_{i = 0}^{7} {N}_{i}^{j} cos ( \frac{( 2 t + 1 ) i π}{16} ) ∀ i ∈ \{ 0 , 1 , … 7 \} , ∀ j ∈ \{ 0 , 1 , … J \}$$

where, Cᵢ=1/sqrt(2) if i=0 & Cᵢ=1 if i>0 ∀iε{0, 1, . . . 7}

There will J number of such vectors.

6. All the 8 DCT coefficients, DCᵢ ∀iε{0, 1, . . . 7}, are then divided by a quantization factor

$${DCQuantized}_{i} = \frac{D {C}_{i}}{1 + Quality \cdot ( 1 + i )} ∀ i ∈ \{ 0 , 1 , … 7 \}$$

This step reduces the importance of the higher cosine frequency components. The quality factor can be defined at the time of compression and it controls how well the higher frequencies components of the signal are suppressed. We typically set the quality at 5.

7. Next we perform the inverse of the DCT operation to regenerate the normal components for each vector N consisting of 8 pieces of component data. Let the regenerated normal component be Nᵢ ∀iε{0, 1, . . . 7}, where

$${N}_{i}^{j ′} = 0.5 {\sum }_{i = 0}^{7} {C}_{i} \cdot {DCQuantized}_{i}^{j} cos ( \frac{( 2 i + 1 ) t π}{16} ) ∀ i ∈ \{ 0 , 1 , … 7 \} , ∀ j ∈ \{ 0 , 1 , … J \}$$

8. When the quality >0, we will see that the regenerated normal component is not the same as the original component. Next, we calculate the root mean square (RMS) error for the entire subdivision for each of the two normal components. The pseudo code to calculate the error is as follows:

error := 0
for ( j :=0; j < J; j := j+1 ) {

for ( i := 0; i < 8; i:= i+1) {

error += (Nᵢ − Nᵢ)²

}

}
error := error / 8J;
error := (error)^{1/2}

At the time of compression, the user can specify the maximum acceptable RMS error. First, we calculate the RMS error for a quality of 5. If the error is greater than the user specified error, we decrease the quality by 1 and repeat the calculation. We continue to decrease the quality to the limit of 0, till the computed RMS error decreases below the user specified maximum RMS error. When the quality is 0, the error is estimated to be zero as well, barring the floating-point computation errors accumulated on a computer.

9. For each of the two normal components, we store the following data:

a. The input Quality number (e.g. 5)

b. A continuous array of quantized DCT coefficients

for (j :=0; j < J; j := j+1 ) {

for (i := 0; i < 8; i:= i+1) {

Store DCQuantizedᵢ^{j}

}

}

10. This continuous array of quantized DCT coefficient is then compressed using a generic lossless text compressor to reduce the inherent redundancy in the data. We have found that we get the best compression by using the same Burrows-Wheeler Transform codecs mentioned in section 8 of this document. In our implementation we have used bzip2 implementation of this codec.

So far very few other attempts have been made to represent the surface data using point-sampled geometry. These attempts have been documented and compared in other sections of this document. To our knowledge, this is the first attempt to compress the surface-normal using the similarity of data between adjacent points without any knowledge of the inherent topology. With this method, we have the ability to compress the normal components in both lossless or lossy manner. If we set the quality to zero in step 6, the normal components are fully recovered by performing the inverse discrete cosine transform. If we set the value of quality to be greater than zero, there is an effect of quantizing the DCT coefficients, which makes the transformation lossy. In the latter case, we do not recover the full information about the normal component, however, in this method we ensure that the RMS error caused by quantization of normal components is lower than the max RMS error given by the user (e.g. 0.0125).

A similar approach using 2D DCT and subsequent adaptive quantization of the coefficients is used by the JPEG image format to perform lossy compression of the images, however, nobody has yet used this method to compress surface-normal-vector data. In the method of JPEG image compression, it is quite common to first perform DCT on the 2D data, then quantize these DCT coefficients. Subsequently, these coefficients are picked up from the 2D image in a zigzag fashion to create a 1D sequence of DCT coefficients. Our method is distinctly different from this approach. We first perform a “wrap-around” on the sparse 3D color image's surface-normal data, then we perform the 1D-DCT and quantization. To repeat the points mentioned in this paragraph, the steps can also be described as follows.

| | |
|---|---|
| JPEG: | 2-Dimensional DCT => Quantize coeff's => Zigzag (2D to |
| | linear) |
| Our Method: | Wrap-around (3D to linear) => 1-Dimensional |
| | DCT => Quantize coeff's |

In our implementation, we have had the most success by subdividing a 3d color image into approximately ˜512-1024 subdivisions. As we decrease the number of subdivisions, the coherence amongst the surface-normal-vectors decreases whereas the normal cone of the subdivision increases. This decrease in similarity of points within the subdivision causes poor compression. It is also important to subdivide enough times. On the other hand, if the model is subdivided too many times, each subdivision will have a very small number of points. The surface normal vector from a very small number of points again does not compress very well in our experience.

Results of Surface-Normal-Vector Compression:

We have achieved excellent compression of the surface-normal data, which we believe can only be achieved by using our method. This method uses an involved arrangement of surface-normal-vector data using our unique encoding method, which makes the surface-normal-vector data amenable to such superior compression. We believe that compression results this good can never be achieved by a generic compressor. We have achieved compression of the surface-normal-vector data from 4-6 bits on an average, and about 2-3 bits per surface normal on average for very smooth surfaces: for example, a sphere. Since we have a lossy encoding method, we can arbitrarily compromise the quality of the surface-normal and improve the compression results even more. In one extreme experiment, we have compressed the surface-normal to 0.15 bits/normal by significantly increasing the level of acceptable deviation of original data from the compressed data. However, such surfaces had visibly unacceptable artifacts in the specular highlights generated by that surface-normal-vector data.

The compression results of this method are listed in Tables 2 and 3. The first column lists the objects that have been used to show the compression results. These objects are mostly the same as the ones listed in Table 1.

TABLE 2
Xyz/Rgb Compression Results with Subdivisions

| | Number of | Number Of | Num. Bits for |
|---|---|---|---|
| Object | points | Subdivisions | XYZ + RGB per point |
| Asparagus | 486,168 | 512 | 8.22 |
| Maple Leaf | 250,304 | 512 | 8.04 |
| Franc | 284,676 | 512 | 11.78 |
| David | 1,423,180 | 512 | 2.64 |
| Hammer | 1,336,812 | 512 | 5.92 |
| Sphere | 307,488 | 512 | 2.86 |

Object: The name of the model. The images of the models listed here are shown in the FIGS. section.
Number of Points: The total number of points in all the subdivisions combined.
Number of Subdivisions: The total number of subdivisions that the 3d color image of the model was divided into.
Number of Bits for XYZ + RGB per Point: Total number of bits for XYZ + RGB divided by total number of points. The position XYZ and color RGB data is encoded with our method within a subdivision and all the data within the subdivisions is combined and then compressed with bzip2.
Note:
A uniform strategy yields from 2.5 to 12 bits per point excluding the normals.

TABLE 3

| | | | | | Average |
|---|---|---|---|---|---|
| | Max. Rms | Bits per ljk | Bits per | | Bits per |
| | error of | normal w/out | ljk normal | | normal |
| | Direction | encoding + | using our | Compression | using |
| Object | cosine | compression | method | ratio | bzip2 |
| Asparagus | 0.012 | 96 | 2.70 | 35.55 | 42.53 |
| Maple | 0.012 | 96 | 2.66 | 36.09 | 22.07 |
| Leaf | | | | | |
| Franc | 0.012 | 96 | 1.99 | 48.24 | 47.61 |
| David | 0.012 | 96 | 4.05 | 23.67 | 40.02 |
| Hammer | 0.012 | 96 | 3.10 | 30.96 | 35.18 |
| Sphere | 0.012 | 96 | 0.53 | 180.11 | 40.09 |

Table 4: Total Xyz/Rqb/ljk Compression Results

Table 4 lists the number of total bits per point for compressed Xyz/Rgb/Ijk point data.

TABLE 4
Total Xyz/Rgb/Ijk Compression Results:
Table 4 lists the number of total bits per point for compressed
Xyz/Rgb/Ijk point data.

| | | | Number of | |
|---|---|---|---|---|
| | | Num. Bits | Bits for | |
| | | for | IJK Surface | Total Number of |
| | Number of | XYZ + RGB | Normal | Bits per |
| Object | points | Points | Vectors | Xyz/Rgb/Ijk Point |
| Asparagus | 486,168 | 8.22 | 2.70 | 10.92 |
| Maple | 250,304 | 8.04 | 2.66 | 10.70 |
| Leaf | | | | |
| Franc | 284,676 | 11.78 | 1.99 | 13.77 |
| David | 1,423,180 | 2.64 | 4.05 | 6.69 |
| Hammer | 1,336,812 | 5.92 | 3.10 | 9.02 |
| Sphere | 307,488 | 2.86 | 0.53 | 3.39 |

Table 4 summarizes the results of this section. Note that the subdivision methods provide total numbers of bits that are as good as the previous results only the normal vectors are also included!

Step 402: Compression of Property Data

Property data tends to be application specific and therefore we cannot provide similar analysis as for the Xyz/Rgb and Ijk portions of the compression description. The main goal of mentioning this is that each property is separated from the Xyz/Rgb/ljk data and separately encoded. The methods would likely be similar to those above in many respects.

Step 500: Channel Bandwidth considerations

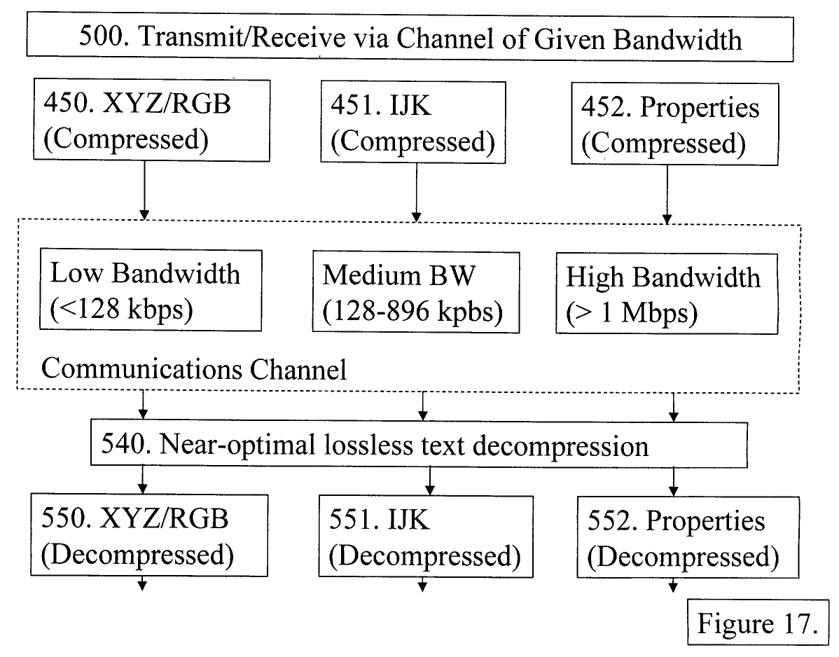

In networked system configurations, such as those encountered when delivering media over the World Wide Web, one may have the advantage of trading off additional processing at the encoding/compression stage or the decompression/decoding phase against the additional time required for additional bytes to be transmitted over the communication medium. Web transmission will general take place in the low and medium bandwidth scenarios indicated in FIG. 17.

For what we call “local” or “kiosk” media delivery configurations, the channel is a high bandwidth channel. In such configurations, it is sometimes beneficial to avoid any compression or coding computations in favor of dealing directly with the uncompressed data.

Step 600: Decoding

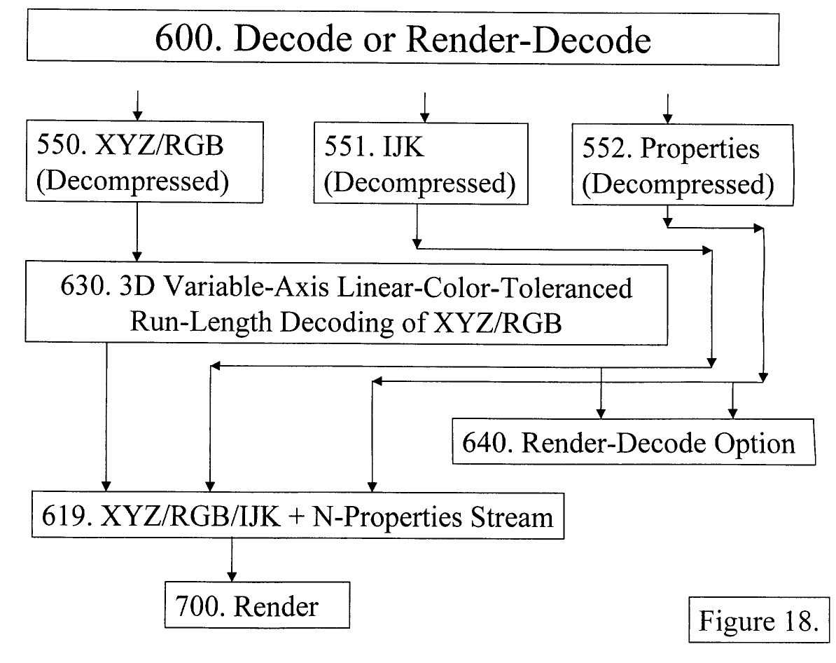

FIG. 18 outlines the recombination of the decompressed information. Since we have labeled our data-reduction processes encoding and compression, then we must do decompression and then decoding at the channel receiver. In a memory-limited client system, there may be advantages to skipping the decoding phase and working directly from our run-length encoded format.

Step 640: Render-Decode Option

For memory-limited client devices, our system allows the possibility of rendering directly from the decompressed data without decoding the 3dRLE information. We simply substitute the rendering loop over points with the decoding loop. The decoding loop is the direct inverse of the encoding loop. This option requires additional computation but allows displays to be done using less memory. For cell phones with displays, an option like this would be relevant.

Step 800: Streaming

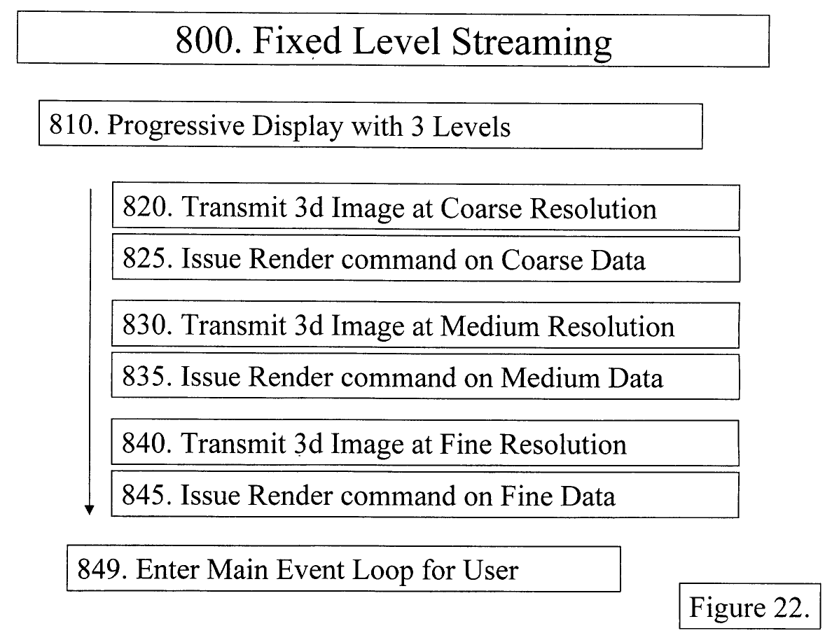

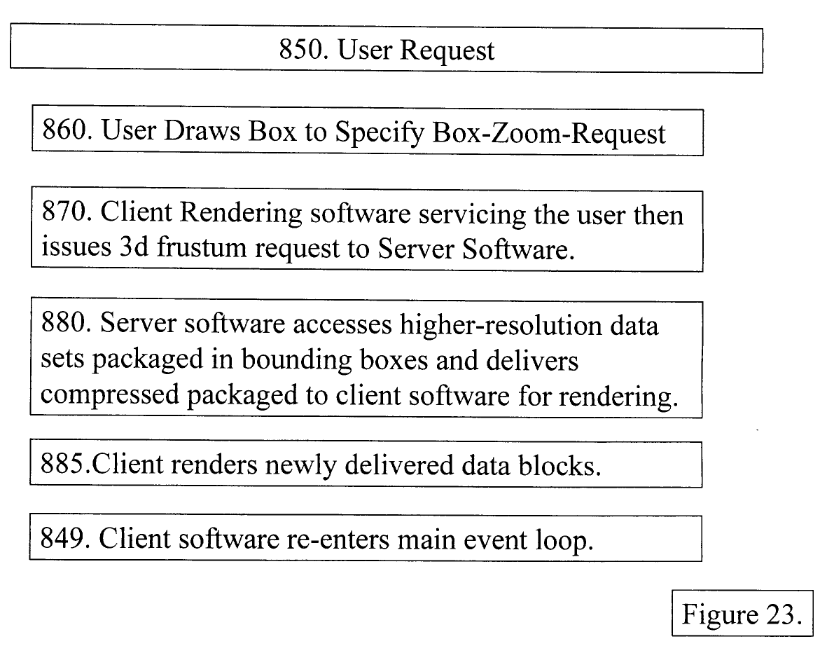

FIG. 22 outlines our simplest streaming concept. Streaming is the technology by which one can begin to view a video sequence or listen to an audio file without transferring the full data set first. In a 3d context, the user is able to see and rotate, zoom, or pan the model without having the full initial version of the model completely loaded into the client viewer. Moreover, the user might for instance choose a box-zooming option whereby additional detail data is delivered to the viewer via a server application. This type of interaction is shown in FIG. 23.

Step 800/810. Multiresolution methods/level of detail methods: While displaying a 3d color image, the most common user-interaction operation is rotation. By drawing groups of points possessing similar pointsizes, the operations of pan and rotate do not require much special attention from a level of detail (LOD) point of view. In contrast, both dolly (change in the z depth of the eye) and zoom (change in effective focal length of the camera/eye lens) functions require special multiresolution processing to maintain high quality views. When zooming or dollying in, 3d color pixels must be drawn increasingly larger. In perspective viewing mode, we can see from the (s/z′) expression above that halving the distance to the eye equivalently doubles the radius of the 2d screen circle that must be drawn for the 3d pixels. Similarly, doubling the eye distance allows for halving the radius of the circle used to draw the 3d color pixels. If the necessary radius of the 2d screen circle is below one-half of a 2d screen pixel, then any strategy that allows for the drawing of fewer pixels enables further speed up of the draw process.

While any given 3d color image with any given sample distance ‘s’ can be drawn with larger circles or with fewer points based on the zooming/dollying in or out, we also have the option with our display scheme to switch to a higher resolution or lower resolution model as is appropriate based on the average behavior of the 3d color image as drawn. Our levels of detail are arranged similar to 2d image pyramids so we also use the term ‘3d color image Pyramid’ with the difference being the extra dimension and the accessing of either ˜8 times more data or ˜8 times less data at each of the transitions. As the user zooms then for example, each drawn pixel could fork into 8 pixels of which 4, 5, 6, or 7 may be visible. We do not use an octree representation as might be common in the field, but rather we switch pointers to the relevant 3d color images as we zoom. The method seems to provide similar or even less popping than the “progressive meshes” with geomorphs as developed by Hoppe [ ], and also gives a progressive transmission option, the reason being that we control visual complexity at the 2d pixel level rather than the 3d polygon level.

Since zooming or dollying in on an object will eventually reach the highest stored resolution level, we must also be specific about the display mechanisms during this process as artifacts will be generated and significantly less data needs to be accessed. Note that in contrast, on zooming out, we can define any level in the pyramid that is simple enough to be what we will call a ‘3d color thumbnail image’. That is the 3d color thumbnail caps the top of the 3d color image pyramid. As we zoom in, it becomes possible to partition out groups of points that are entire off the screen, or entirely not visible based on coarse level visibility tests.

Suppose that we have a cube surrounding a 3d color image that was digitized from a solid object so that the set of 3d color pixels form a solid when embedded in the appropriate resolution voxel grid. As an example, imagine that we coarsely bin this set of points into an 8×8×8 coarse voxel grid. This is a very simple form of organizing or subdividing the data. Each coarse voxel cube in this set of 512 cubes can be classified: it lies completely outside the object, it lies completely inside the object, or it lies on the boundary of the object's representation. For any voxels that are contained completely inside the object, we know that they will project to a completely covered 2d area representing the projection of a solid cube. The following observations can be made:

(1) First, note that only boundary voxel cubes contain 3d pixels that need to be drawn in our representation;

(2) Clip Test: If a boundary voxel cube does not project onto the viewing window, then none of its 3d color pixel contents need to be drawn;

(3) Visibility Test: If a boundary voxel cube is occluded in a given view by the set of interior voxel cubes, then none of its 3d color pixel contents need to be drawn;

(4) If a boundary voxel cube is classified as clipped in this view, it is likely to be clipped in the subsequent view;

(5) If a boundary voxel cube is classified as occluded in this view, it is likely to be occluded in the subsequent view.

In general, whether transmitting 3d color image data or drawing the 3d color image data on a computer screen, effective and efficient use of these observations can provide possible speed improvements over conventional polygonal models.

In accordance with the present invention, an image may be transmitted by downloading all necessary 3d color image information up to a given resolution level, or inter-point spacing level, and then delivering 2d renderings from that data, as long as selected quality criteria are met, as well as any methods that generate a server request to provide additional higher resolution data when it is available or to acknowledge and “fake it” when such higher resolution data is not available, or any other user settable behavior for providing high quality 2d screen imagery in a distributed environment based on the 3d color image data structure or the 3d Xyz/Rgb pointstream.

“3d icons” application: This invention also includes the ‘3d color thumbnail image’ concept mentioned above. A 3d color thumbnail image is package of bytes sufficient to provide iconic thumbnail images which the user is able to rotate within a small rectangle of the screen image using the mouse or other peripheral device. The 3d color thumbnail is a natural icon to use when accessing 3d model databases and when icons larger than 16×16 or 32×32 are used. By rendering from a low resolution 3d color image data structure, the quality of such coarse models can be improved over rendering from polygonal models. This has been verified experimentally in subjective experiments. Such low resolution 3d display models may be very useful in the upcoming 3G wireless handset market, such as NTT DoCoMo.

Rotatable and scaleable 3D images made and rendered according to the present invention may be used to illustrate icons, cursors, application logos or signature logos in the place of or in addition to conventional bitmaps or animated GIFs. The present invention includes such a use of a 3d color image or Xyz/Rgb pointstream as defined above in conjunction with any type of user-interface control element so that the user of software equipped with such an invention will be able to rotate, pan, dolly, or zoom, or request a higher resolution version of the attached and probably hyper-linked or href d data set. We claim as our invention the embodiment of this concept in User Interface Controls, Buttons, HTML Links, XML links, email signatures, embedded document graphics.

The present invention may be used to enhance the quality and speed of graphic representations in all aspects of graphic display in all its forms from 32×32 bit icons to 128×128 handheld color screens to 32000×32000 picture walls.

We believe this part of our invention satisfies an as-yet unidentified need to have complete 3d control over any computer content. For example, the Netscape logo displayed in the Netscape™ browser was one of the first popular type of animated GIF presentation. With the present invention, you would not only witness the animation of stars falling past the earth with the big N, you would also be able to rotate the earth and the N and see the animated articulated shapes in real-time simply by placing the cursor or other UI control item over the nominally 2d image and be able to perform all the aforementioned 3d functions, including the request for higher resolution information.

Just as we have seen Windows icons of folders go from black and white to color to gradient color, we expect an eventual transition to the invention of 3d icons/bitmaps/cursors/etc. The amount of data is not nearly as large as one might think and as we describe in Method 12, the amount of CPU and graphics capabilities is also not what one might think prior to this invention.

Step 810: “like a 3d progressive JPEG”: The 3d color pyramid allows progressive transmission of 3d color image data. For lower resolution images, it is critical to coarse image quality that RGB's be averaged for the spatial position that is occupied by the given point. Other existing methods of rendering from point data do not seem to take this into account or they require extensive tree traversal for the highest resolution renderings. The 3d color pyramid is analogous to a progressive JPEG image in some ways as it will appear to be very similar on the screen until the user actually can rotate the object rather than just look at an image. The average user in the future may describe this invention as a “rotate-able, pan-able, zoom-able, dolly-able, progressive JPEG” whether in its thumbnail/icon/bitmap/cursor realization or in its full screen or partial screen higher resolution realization.

Step 700. Simple Rendering Methods: Rendering using only 3d color pixels with normals is achieved using only a system dependent image transfer operation along with very generic system independent CPU operations. Specialized Mip-Mapping hardware for texture maps, etc, specialized polygon fragment processors are not needed. The simple rendering algorithm is outlined in FIG. 19. The inventive aspect of this algorithm is that it is capable of extremely realistic displays without any complex subsystems. All the source code fits on less than 2 pages.

For purposes of discussion, we presume that a real implementation will want a full scene-graph capability. We refer to this a “pointstream document.” The 3d color images can be arranged in arbitrary hierarchies, typical of graphic systems.

Step 710: Render the document in a viewing window by traversing the scene graph/hierarchy.

Step 715: Render each composite entity via recursive invocation of this rendering procedure.

Step 720: Render a 3d color image object (a.k.a. pointstream).

Step 730: Push rotation matrix and translation vector of object onto matrix stack. This will yield the complete 3d matrix transformation for the given object.

Step 740: For each point in the object, do the following:

Step 750: Rotate and translate the point using the current composite matrix from the matrix stack which includes the effects of the viewing matrix. Use perspective or orthographic projection as specified by user. This requires 6 multiplies (+2 divisions for perspective) +8 additions.

Step 760: Clip point to the viewing window. This requires 4 if statements.

Step 770: Optionally, shade point using Lights and Materials. We refer to this as the ShadePixel( ) function.

Step 780: Add point information to framebuffer of viewing window accessing the windows z-buffer also. We refer to this as the AddPixel( ) function.

Step 790. Pop transformation stack once all the points of an object are rendered.

Step 798. When all points of all objects are rendered, show the framebuffer on the screen. In double-buffered situations, this would be the “swapbuffer” execution.

Full Details

Here is a totally generic software-based double buffered implementation. The invention requires only that these functions be accomplished via assembler enhancements, MMX enhancements, or multi-pipelined enhancements within the context of the generic CPU using generic cache and generic memory.

Here is a sample C type implementation of rendering.

static void *frontbitmap=NULL;

static void *backbitmap=NULL;

static BITMAPINFO *frontinfo=NULL;

static BITMAPINFO *backinfo=NULL;

static unsigned char backgroundval=0;

static int framecount=0;

void Draw3dColorImage(HWND hWnd, HDC hDC, //system,window,device refs ImageModel *pModel, //3d color image model View *pView) // 3d view

{

//
// Get Size of Window to Draw In
//
RECT wrect;
GetWindowRect(hWnd, &wrect); // ← system call for Window Size
int nx = abs( wrect.right − wrect.left );
int ny = abs( wrect.bottom − wrect.top );
//
// Allocate Device Independent Bitmaps if Not Allocated
//
if( !frontbitmap ) { frontbitmap = AllocDIB(&frontinfo, nx, ny); }
if( !backbitmap ) { backbitmap = AllocDIB(&backinfo, nx, ny); }
unsigned char *bitmap = NULL;
if( (framecount & 0x1) )
{
bitmap = (unsigned char *)frontbitmap;
info = frontinfo;
memset(frontbitmap,backgroundval,sizeof(char)*3*nx*ny);

}
else
{

bitmap = (unsigned char *)backbitmap;
info = backinfo;
memset(backbitmap, backgroundval,sizeof(char)*3*nx*ny);

}
// Get 3d View Xform and Bitmap Offset
//
double off[2];
double rot[4][4];
pView->GetMatrix(rot, off);
float xyz[3]; // point position
float ijk[3]; // point surface normal
unsigned char rgb[3]; // point color
for(k=0;k < pModel->NumberOfPoints( ); ++k )
{

| pModel->GetPoint(k, xyz, rgb, ijk ); | |
|---|---|
| // | |
| // Rotate, Translate, and Project to 2D | |
| // | |
| uvw[0] = | rot[0][0]*xyz[0] + rot[1][0]*xyz[1] + |
| | rot[2][0]*xyz[2] + rot[3][0]; |
| uvw[1] = | rot[0][1]*xyz[0] + rot[1][1]*xyz[1] + |
| | rot[2][1]*xyz[2] + rot[3][1]; |
| uvw[2] = | rot[0][2]*xyz[0] + rot[1][2]*xyz[1] + |
| | rot[2][2]*xyz[2] + rot[3][2]; |

if( pView->Perspective( ) )
{

uvw[0] = off[0] + uvw[0]/uvw[2];
uvw[1] = off[1] + uvw[1]/uvw[2];

}
else // Orthographic projection
{

uvw[0] = off[0] + uvw[0];
uvw[1] = off[1] + uvw[1];

}
//
// Screen Clipping is easy
//
if( uvw[0] < 0 ) continue;
if( uvw[0] > nx−1 ) continue;
if( uvw[1] < 0 ) continue;
if( uvw[1] > ny−1 ) continue;
//
// Deposit 3d Color Point as Pixel(s) in Image
//
ix = (int)(uvw[0]+0.5);
iy = (int)(uvw[1]+0.5);
ipixel = 3*(nx*iy + ix);
ShadePixel( color,xyz,rgb,ijk,

pView->LightingParams, pModel->Material Props );

bitmap[ipixel+0] = color[0];

bitmap[ipixel+1] = color[1];
bitmap[ipixel+2] = color[2];
//
// Add Neighboring Pixels for Larger Point Sizes
//
AddPixel( bitmap, ipixel, color, PointSize(xyz,pView) );

}
//
// Send Memory Version of Image to be the Screen Version via
// system supplied memory transfer function.
//
SetDIBitsToDevice(hDC,0,0, nx,ny, 0,0, 0,ny,

frontbitmap,frontinfo DIB_RGB_COLORS);

++framecount
return;

}

Further Discussion of Shading, Lighting, and Materials

The details of whatever conventional lighting model to be used combined with the material properties of a model is implemented inside of ShadePixel( ). The simplest non-lighted display occurs where color=rgb and where all other information is ignored. The AddPixel( ) procedure is used when the size of the point on the screen needs to be bigger than a single pixel and is customized for view-dependent z determination of pointsize. We claim that any real-time graphics algorithm that can be implemented for polygons can be implemented for points. Note that this very simple loop can in theory generate displays nearly equivalent to what the best graphics hardware and software and the best texture-mapped models can create in any single pass operation. This approach allows the display methods of this invention to be used on simple devices that do not support advanced graphics libraries, such as OpenGL or Direct3D.

Anti-Aliasing: We also claim as a part of this invention the numerous methods of anti-aliasing or multisampling the above type of basic one-pass rendering algorithm. For example, it is quite reasonable to use either a fixed size accumulation buffer method to anti-alias a given display using CPU power instead of memory to improve this display. In addition, what SGI called multisampling is so easy in this context that specialized hardware is not required for high quality anti-aliased renderings. Rather we simply render into a 8× by 8× times larger image in memory. When we bit-blit to the screen, we average in the 2×2 or 4×4 or 8×8 subpixels to determine the actual output screen pixel value. This multi-sampling or super-sampling anti-aliasing method is very realizable with only very generic requirements. The image quality will be stunning given the remarkable simplicity of the algorithm above and simple well-known pixel averaging on output.

Static Faux Lighting Option

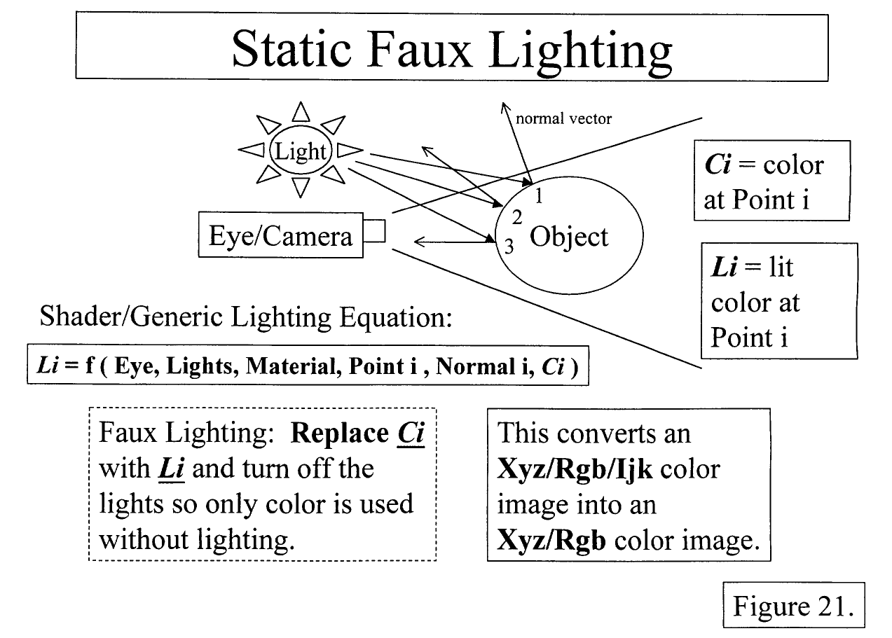

Our smallest file, good quality 3d images are rendered using what we refer to as a “faux” lighting trick. In FIG. 21, we see a diagrammatic representation of a light illuminating an object that is viewed by a camera/eye. The rgb value of a pixel on the computer screen is a function of the eye position, light positions and properties, material properties, and the ith point, ith normal vector, and ith color. When we move the object and not the light, our rendering algorithm provides the updates since ShadePixel( ) will execute in the new viewing situation even though the light is in the same place. When we move the light and not the object, ShadePixel( ) still does just as much significant work as in the previous case. The same thing is true of the situation where we move the light and the view.

Now, imagine that we call ShadePixel( ) on each 3d point with its 3d normal and color values given the eye, light(s), and material properties. This results in a new Rgb color value which is generally only applied to a 2d pixel in most graphics situations. Here is a major inventive advantage of our 3d color image system. We can do a “faux lighting” operation on the data. If the color at 3d pixel is (r, g, b), once we compute the Rgb value described above, we can replace the (r, g, b) value at the point with new true lighting Rgb value computed by applying ShadePixel( ). In addition, we also turn off the lighting computation after said replacement. Then as we rotate the model, the color values at the points become “faux lighting” values that mimic the appearance of a fixed light source, yet require no further ShadePixel( ) computations and therefore, require no further access to point normals. If we then package the “faux lighting” colors with the point Xyz values, compress using only Xyz/Rgb compression (no normal compression required because there are no normals), we create a very small files that is typically improved in appearance compared to the original Xyz/Rgb data, yet is only marginally larger.

Fast 3d Color Image Rotation Method

Our decoded points lie at sparse locations within a regular voxel grid. This allows us to do 3d rendering with fewer operations per point than one might expect. Instead of what would be the rough equivalent of 8 multiplies and 8 adds per point when transforming points, there is an alternative methods requiring only full transformation of a single point in a point cloud followed by 5 additions, 3 multiplies, and 2 divisions per point. The basic underlying idea is that if you transform the basis vectors of the voxel grid that the 3d color image can be embedded in, then the XYZ in screen space is computed via 3 adds and 3 multiplies, or even 6 adds. 2 more divisions and 2 more adds are required for perspective projection.

This is fewer operations than is required by our other techniques but there is no loss in generality of the method.

Partial Details

For each xIndex

iXTerm=iMin+xIndex*iXₑ

For each yIndex

iXYTerm=iXTerm+yIndex*iYₑ

iXYTerm[0]*=int(P[0][0])

iXYTerm[1]*=int(P[1][1])

For each zIndex

iz_{screen}=zIndex*iZₑ[2]+iXYTerm[2]

ix_{screen}=(zIndex*iZₑ[0]+iXYTerm[0])/iZ_{screen}+int(screenOffset[0])

iy_{screen}=(zIndex*iZₑ[1]+iXYTerm[1])/iZ_{screen}+int(screenOffset[1])

Combination of 3D color point models with other 3D models

Many objects are best imaged and rendered using the 3D color point models of the present invention. However, certain types of objects may be efficiently imaged and rendered using other techniques such as Nurbs-type curves or surfaces, Bezier curves and surface, arbitrary polygons, triangle mesh models, video sources mapped onto graphic objects and other techniques. Each of the geometric techniques may or may not incorporate texture mapping. In this section, we are referring to the ability of our methods to be combined with graphic objects that are NOT converted into 3d color images.

The 3D color point models of the present invention may be combined with any of these methods to produce a complete hybrid image of either a single object (which has different portions that are more efficiently rendered using different techniques) or different objects in the scene. Different objects that are rendered using different techniques may be moved in front of or behind of one other and may occlude one another using a standard z-buffer.

Alternatively, different layers of an image (i.e. a multimedia image) may be rendered using different techniques. For example a complex foreground object may be rendered using the 3D color point models may be combined with a video background source or a simple background image.

Interactions between different objects and layers, or both, may be addressed by adding alpha channel data to the 3D color point models of the present invention to define characteristics such a opaqueness, etc.

The present invention has been described in the context of objects that may be scanned statically. As scanning technology evolves, dynamic 3D scanning of moving objects is becoming practical. The present invention may be used to assemble multiple representations (having different sizes or levels of detail), and to render scalable and rotatable 3D images of such objects in real time. For example, a movie scene may be imaged using a set of 3D color scanners. A scene may be rendered according to the present invention such that it may be interactively viewed from different viewpoints.

One set of methods for implementing and using the present inventive method of forming, rendering and compressing, transmitting, and decompressing a 3D image have been described. Many variations of these methods are possible. Some of these are described below.

Partial or Complete Hardware/Firmware Implementation of Above Algorithms

Although a significant advantage of the invention is the simplicity for use with general purpose computing hardware, further speed enhancements are also possible by embedding the simple algorithms wholly or partially in a custom ASIC hardware implementation or DSP implementation. The present invention includes the idea of creating a hardware or firmware implementation of the encoder, the decoder, the renderer and/or other components. Such variations may be especially useful in versions of the invention adapted for a special purpose. Included in this description, is the explicit inclusion of pointsize in vertexArrays with the equivalent status of color, normal vectors, and point locations.

Sphere or other Primitive Method for Point Rendering Without Normals

Points can be rendered in a lit manner as small spheres or other approximating geometric primitive shape. If each primitive is shaded by a light source direction, the resulting image will have an appearance not otherwise attainable. For infinite light sources, bitmaps of the spheres at quantized depths could be computed to allow faster rendering than would be possible otherwise given that bitmap access can be done efficiently.

Step 760: Clipping of Point Primitives

Geometry clipping during point rendering is generally quite simple as far as conventional graphics libraries are concerned. However, when Points or 3d Pixels are drawn in a large pointsize near the border of an image, certain undesirable results may occur. For example, if the average pointsize in a neighborhood of the screen is, for example, ten 2d image pixels, and if the surface area covered by the 3d points is relatively thin, there will be a drop area around the image border where the center of the ten 2d pixel points lie off the screen. There are 2d pixels on the screen that should be painted by the 3d point, however, they are not painted when the center of the pixel is clipped. This undesirable effect is illustrated in Algorithm 1 below.

Algorithm 1. Basic Point Clipping

Project 3d point to 2d. 3d point maps to pixel center (ix, iy). Pixel size (ips). Clip test:

If ix<0 Then continue;

If iy<0 Then continue;

If ix>(nx−1) Then continue; //for nx by ny image

If iy>(ny−1) Then continue; //for nx by ny image.

Draw (ix, iy) pixel using Pixel Size (ips)

Undesirable Effect: If (ix, iy) is out of window, but point is needed to cover 2d pixels near the edge of a viewing window, then basic point clipping eliminates the pixel filling that should take place near the edge of the image.

To solve this problem, the conventional point clipping algorithm may be modified as illustrated in Algorithm 2 below.

Algorithm 2. Enhanced Point Clipping with Details of Pixel Fill In

Project 3d point to 2d. 3d point maps to pixel center (ix, iy). Pixel size (ips).

Let (ipshalf) equal half the displayed point size.

Clip test:

If ix<(−halfsize) Then continue;

If iy<(−halfsize) Then continue;

If ix>(nx−1+halfsize) Then continue; //for nx by ny image

If iy>(ny−1+halfsize) Then continue; //for nx by ny image

Draw (ix, iy) pixel using Pixel Size (ips)

By not eliminating consideration of a point that is slightly out-of-window, the pixels near the edge of the screen can be filled satisfactorily using a software zbuffer algorithm such as the following. SetRGBZ only updates a pixel if the z value has precedence of the existing z buffer value at that 2d pixel.

Details of Point Fill Algorithm for Drawing Pixel at (ix, iy)

| | |
|---|---|
| if( nY <= halfSize ) | { kYstart = 0; } |
| else | { kYstart = nY − halfSize; } |
| if( nY >= this->m_nHeight−1−halfSize ) | { kYstop = this->m_nHeight−1; } |
| else | { kYstop = nY + halfSize; } |
| if( nX <= halfSize ) | { kXstart = 0; } |
| else | { kXstart = nX − halfSize; } |
| if( nX >= this->m_nWidth−1−halfSize ) | { kXstop = this->m_nWidth−1; } |
| else | { kXstop = nX + halfSize; } |
| for( kY = kYstart; kY <= kYstop; ++kY ) | |

{

for( kX = kXstart; kX <= kXstop; ++kX )
{

int dX = kX − iX;
int dY = kY − iY;
int iR2 = dX*dX + dY*dY;
if( iR2 <= iPointRadius2 )
{

SetRGBZ(kX,kY ,r,g,b,zBufferValue);

}

}

}

Step 780: Additional Possibilities for AddPixel( ) Method

When a pixel is added to the framebuffer and the surface normal vector is known, it is possible to pre-compute tilted bitmaps for the pixel layout that provide (a) fewer pixels to turn on in the color buffer and the z-buffer, and (b) better edge definition along occluding contours.

Step 715. Hierarchical Arrangement of 3d Color Images for Animation.

By allowing an Entity in a modeling system to be either a Composite, an Instance, or an Object consisting of 3d Color Image data, this invention can be generalized to allow functions of a conventional graphic system. A Composite is defined as a list of Entities.

An Instance is a pointer to an Object with a shader and transform definition. An Object contains the actual geometry of the 3d Color Image possibly in some combination with conventional polyline data, triangle mesh data, spline curve data, or spline surface data.

Deformation and Morphing of 3d Color Images

A color point cloud can be deformed using conventional free-form deformation techniques. A significant deformation that causes nearby points to separate by more than the uniform sample spacing will cause a problem for the simple rendering algorithm of the present invention. One algorithm is to track nearest neighbors of each point and to recursively insert midpoints as needed to maintain adequate spacing. Another alternative is to use a 3d generalization of 2d image morphing on the same sampling grid structure that was used to provide a uniform sampling.

A person skilled in the art will be capable of implementing these and other variations of the present invention. All such variations and modifications fall within the scope of the present invention, which is limited only by the appended claims.

All of the following publicly available documents are incorporated herein by this reference.

Y. Yemez and F. Schmitt, “Progressive Multilevel Meshes from Octree Particles”, Proceedings of 2nd Int'l Conf 3d Imaging & Modeling, Ottawa, Canada, October 1999, pp. 290-301.

Gernot Schaufler and Henrik W. Jensen, “Ray tracing point sampled geometry,” Technical Report. Referenced on Stanford graphics home page.

Matthias Zwicker, Markus H. Gross, Hans Peter Pfister, “A Survey and Classification of Real Time Rendering Methods,” Technical Report 2000-09, Mar. 29, 2000, Mitsubishi Electric Research Laboratories, Cambridge Research Center. (about surfers).

Hanspeter Pfister, Matthias Zwicker, Jeroen van Baar, Markus Gross, “Surfels: Surface Elements as Rendering Primitives,” SIGGRAPH 2000, ACM, pages 335-342.

Szymon Rusinkiewicz and Marc Levoy, “Streaming QSplat: A Viewer for Networked Visualization of Large, Dense Models,” November 2000. Levoy home page.

Szymon Rusinkiewicz and Marc Levoy, “QSplat: A Multiresolution Point rendering system for large meshes,” Siggraph 2000, ACM, pages 343-352.

OpenGL Programming Guide, 2nd Edition, Addison-Wesley, Reading, Mass., 1997.

Color Triclops scanner described at http://www.ptgrey.com. A commercial sensor generating a real-time Xyz/Rgb data stream.

Zcam described at http://www.3dvsystems.com. A commercial sensor generating real-time Xyz/Rgb image sequences.

Bzip2 References

Michael Burrows and D. J. Wheeler: “A block-sorting lossless data compression algorithm” May 10, 1994. Digital SRC Research Report 124. ftp://ftp.digital.com/pub/DEC/SRC/research-reports/SRC-124.ps.gz

Daniel S. Hirschberg and Debra A. LeLewer “Efficient Decoding of Prefix Codes” Communications of the ACM, April 1990, Vol 33, Number 4.

David J. Wheeler Program bred3.c and accompanying document bred3.ps. ftp://ftp.cl.cam.ac.uk/users/djw3/

Jon L. Bentley and Robert Sedgewick “Fast Algorithms for Sorting and Searching Strings” see www.cs.princeton.edu/˜rs

Peter Fenwick: Block Sorting Text Compression Proceedings of the 19th Australasian Computer Science Conference, Melbourne, Australia. Jan. 31-Feb. 2, 1996. ftp://ftp.cs.auckland.ac.nz/pub/peter-f/ACSC96paper.ps

Julian Seward: On the Performance of BWT Sorting Algorithms Proceedings of the IEEE Data Compression Conference 2000 Snowbird, Utah. Mar. 28-30 2000.

We claim:

1. A method for producing 2d computer graphics screen images from 3d color image data representing an object or a scene, the method comprising:
constructing a hybrid 3d point/pixel/voxel color image pyramid model of an object or a scene that displays on a 2d medium, such as a computer screen or a photographic color print, in a manner giving the illusion that the model is a solid shape and/or possesses a surface representation of smooth surfaces or interconnected polygons, yet not utilizing conventional computer graphic representations, such as polygons or texture maps, or the memory required by same, or the numeric processing paths within 3d graphics cards, and
producing computer graphics images according to lighting and viewing parameters using a hybrid 3d point-pixel-voxel image pyramid model with color attributes at each point that may represent the actual color of the real world object or scene, or any other physical parameter, such a temperature or pressure, that is color mapped to the given point-pixel-voxel.
